(19) United States
(12) Patent Application Publication
(10) Pub. No.: US 2008/0125877 A1
(43) Pub. Date: May 29, 2008

(54) Process data collection system configuration for process plant diagnostics development

(75) Inventors: John P. Miller, Eden Prairie, MN (US); Marcus R. Lundeberg, Bloomington, MN (US)

Correspondence Address: MARSHALL, GERSTEIN & BORUN LLP (FISHER), 233 SOUTH WACKER DRIVE, 6300 SEARS TOWER, CHICAGO, IL, 60606, US

(73) Assignee: FISHER-ROSEMOUNT SYSTEMS, INC., Austin, TX (US)

(21) Appl. No.: 11/531,080

(22) Filed: Sep. 12, 2006

(51) Int. Cl. G05B 13/04; G06F 3/048; G06F 17/30

(52) U.S. Cl. 700/29; 715/771; 707/104.1; 707/E17.001

(57) ABSTRACT

A number of techniques are disclosed to facilitate process data collection and monitoring. The techniques may involve and support the selection of process parameters to be monitored, including scanning techniques for automated identification of such parameters. The techniques may also involve the management of data storage and archiving operations to facilitate continued process data collection arising from an on-line process. In these and other ways, the disclosed techniques are well-suited for process data collection and monitoring in connection with diagnostic elements of a process control system and other contexts involving process status indicators and the underlying process variables.

### RELATED APPLICATIONS

This application is related to the following patent applications, which are being filed as U.S. non-provisional applications on the same date as this application and which this application hereby expressly incorporates by reference herein in their entirety: “Process Data Storage for Process Plant Diagnostics Development” (Atty. Docket Nos. 3090 PT and 30203/41609) and “Process Data Collection for Process Plant Diagnostics Development” (Atty. Docket Nos. 3089 PT and 30203/41611).

### TECHNICAL FIELD

This disclosure relates generally to process plant diagnostics and, more particularly, to collecting process data to support the development and implementation of process plant diagnostics.

### DESCRIPTION OF THE RELATED ART

Process control systems, like those used in chemical, petroleum or other processes, typically include one or more centralized or decentralized process controllers communicatively coupled to at least one host or operator workstation and to one or more process control and instrumentation devices such as, for example, field devices, via analog, digital or combined analog/digital buses. Field devices, which may be, for example, valves, valve positioners, switches, transmitters, and sensors (e.g., temperature, pressure, and flow rate sensors), are located within the process plant environment, and perform functions within the process such as opening or closing valves, measuring process parameters, increasing or decreasing fluid flow, etc. Smart field devices such as field devices conforming to the well-known FOUNDATION™ Fieldbus (hereinafter “Fieldbus”) protocol or the HART® protocol may also perform control calculations, alarming functions, and other control functions commonly implemented within the process controller.

The process controllers, which are typically located within the process plant environment, receive signals indicative of process measurements or process variables made by or associated with the field devices and/or other information pertaining to the field devices, and execute controller applications. The controller applications implement, for example, different control modules that make process control decisions, generate control signals based on the received information, and coordinate with the control modules or blocks being performed in the field devices such as HART and Fieldbus field devices. The control modules in the process controllers send the control signals over the communication lines or signal paths to the field devices, to thereby control the operation of the process.

Information from the field devices and the process controllers is typically made available to one or more other hardware devices such as operator workstations, maintenance workstations, personal computers, handheld devices, data historians, report generators, centralized databases, etc., to enable an operator or a maintenance person to perform desired functions with respect to the process such as, for example, changing settings of the process control routine, modifying the operation of the control modules within the process controllers or the smart field devices, viewing the current state of the process or of particular devices within the process plant, viewing alarms generated by field devices and process controllers, simulating the operation of the process for the purpose of training personnel or testing the process control software, diagnosing problems or hardware failures within the process plant, etc.

As is known, problems frequently arise within a process plant environment, especially a process plant having a large number of field devices and supporting equipment. These problems may take the form of broken or malfunctioning devices, logic elements, such as software routines, being in improper modes, process control loops being improperly tuned, one or more failures in communications between devices within the process plant, etc. These and other problems while numerous in nature, generally result in the process operating in an abnormal state (i.e., the process plant being in an abnormal situation) which is usually associated with suboptimal performance of the process plant. Many diagnostic tools and applications have been developed to detect and determine the cause of problems within a process plant and to assist an operator or a maintenance person to diagnose and correct the problems, once the problems have occurred and been detected. For example, operator workstations, which are typically connected to the process controllers through communication connections such as a direct or wireless bus, Ethernet, modem, phone line, and the like, have processors and memories that are adapted to run software, such as the DeltaV™ and Ovation control systems, sold by Emerson Process Management. These control systems have numerous control module and control loop diagnostic tools. Likewise, maintenance workstations, which may be connected to the process control devices, such as field devices, via the same communication connections as the controller applications, or via different communication connections, such as OPC connections, handheld connections, etc., typically include one or more applications designed to view maintenance alarms and alerts generated by field devices within the process plant, to test devices within the process plant and to perform maintenance activities on the field devices and other devices within the process plant. Similar diagnostic applications have been developed to diagnose problems within the supporting equipment within the process plant.

Thus, for example, software available commercially as the AMS™ Suite: Intelligent Device Manager from Emerson Process Management enables communication with and stores data pertaining to field devices to ascertain and track the operating state of the field devices. See also U.S. Pat. No. 5,960,214 entitled “Integrated Communication Network for use in a Field Device Management System”). In some instances, the AMS™ software may be used to communicate with a field device to change parameters within the field device, to cause the field device to run applications on itself such as, for example, self-calibration routines or self-diagnostic routines, to obtain information about the status or health of the field device, etc. This information may include, for example, status information (e.g., whether an alarm or other similar event has occurred), device configuration information (e.g., the manner in which the field device is currently or may be configured and the type of measuring units used by the field device), device parameters (e.g., the field device range values and other parameters), etc. Of course, this information may be used by a maintenance person to monitor, maintain, and/or diagnose problems with field devices.

Similarly, many process plants have included software applications such as, for example, RBMware provided by CSI Systems, to monitor, diagnose, and optimize the operating state of various rotating equipment. Maintenance personnel usually use these applications to maintain and oversee the performance of rotating equipment in the plant, to determine problems with the rotating equipment, and to determine when and if the rotating equipment must be repaired or replaced. Similarly, many process plants include power control and diagnostic applications such as those provided by, for example, the Liebert and ASCO companies, to control and maintain the power generation and distribution equipment. It is also known to run control optimization applications such as, for example, real-time optimizers (RTO+), within a process plant to optimize the control activities of the process plant. Such optimization applications typically use complex algorithms and/or models of the process plant to predict how inputs may be changed to optimize operation of the process plant with respect to some desired optimization variable such as, for example, profit.

These and other diagnostic and optimization applications are typically implemented on a system-wide basis in one or more of the operator or maintenance workstations, and may provide preconfigured displays to the operator or maintenance personnel regarding the operating state of the process plant, or the devices and equipment within the process plant. Typical displays include alarming displays that receive alarms generated by the process controllers or other devices within the process plant, control displays indicating the operating state of the process controllers and other devices within the process plant, maintenance displays indicating the operating state of the devices within the process plant, etc. Likewise, these and other diagnostic applications may enable an operator or a maintenance person to retune a control loop or to reset other control parameters, to run a test on one or more field devices to determine the current status of those field devices, or to calibrate field devices or other equipment.

While these various applications and tools are very helpful in identifying and correcting problems within a process plant, these diagnostic applications are generally configured to be used only after a problem has already occurred within a process plant and, therefore, after an abnormal situation already exists within the plant. Unfortunately, an abnormal situation may exist for some time before it is detected, identified and corrected using these tools, resulting in the suboptimal performance of the process plant for the period of time during which the problem is detected, identified and corrected. In many cases, a control operator will first detect that some problem exists based on alarms, alerts or poor performance of the process plant. The operator will then notify the maintenance personnel of the potential problem. The maintenance personnel may or may not detect an actual problem and may need further prompting before actually running tests or other diagnostic applications, or performing other activities needed to identify the actual problem. Once the problem is identified, the maintenance personnel may need to order parts and schedule a maintenance procedure, all of which may result in a significant period of time between the occurrence of a problem and the correction of that problem, during which time the process plant runs in an abnormal situation generally associated with the sub-optimal operation of the plant.

Additionally, many process plants can experience an abnormal situation which results in significant costs or damage within the plant in a relatively short amount of time. For example, some abnormal situations can cause significant damage to equipment, the loss of raw materials, or significant unexpected downtime within the process plant if these abnormal situations exist for even a short amount of time. Thus, merely detecting a problem within the plant after the problem has occurred, no matter how quickly the problem is corrected, may still result in significant loss or damage within the process plant. As a result, it is desirable to try to prevent abnormal situations from arising in the first place, instead of simply trying to react to and correct problems within the process plant after an abnormal situation arises.

One technique that may be used to collect data that enables a user to predict the occurrence of certain abnormal situations within a process plant before these abnormal situations actually arise, with the purpose of taking steps to prevent the predicted abnormal situation before any significant loss within the process plant takes place. This procedure is disclosed in U.S. patent application Ser. No. 09/972,078, now U.S. Pat. No. 7,085,610, entitled “Root Cause Diagnostics” (based in part on U.S. patent application Ser. No. 08/623,569, now U.S. Pat. No. 6,017,143). The entire disclosures of both of these applications are hereby incorporated by reference herein. Generally speaking, this technique places statistical data collection and processing blocks or statistical processing monitoring (SPM) blocks, in each of a number of devices, such as field devices, within a process plant. The statistical data collection and processing blocks collect process variable data and determine certain statistical measures associated with the collected data, such as the mean, median, standard deviation, etc. These statistical measures may then be sent to a user and analyzed to recognize patterns suggesting the future occurrence of a known abnormal situation. Once a particular suspected future abnormal situation is detected, steps may be taken to correct the underlying problem, thereby avoiding the abnormal situation in the first place.

Often, the identification of an abnormal situation amounts to only the beginning of the process to develop a technique for future detection of the abnormal situation. Detection techniques may still need to be developed to detect that an abnormal condition has occurred, or will occur, in a certain piece of process equipment. Even if the techniques to detect abnormal situations can be developed by experts, the resulting techniques are typically first tested and verified in the field before actual installation. Only after the tests in the field verify the detection technique are plant personnel likely to rely on the technique to monitor an actual operating plant.

Such field tests often involve the collection and storage of vast amounts of process data. Detailed data collection occurs during development, in which case the process parameters for which data should be collected may not be known with certainty. Moreover, one may not know when the abnormal situation will occur, thereby necessitating continuous and long-term data collection lasting, for example, several months. Furthermore, because some abnormal situations occur very quickly (e.g., on the order of seconds), it is often useful to store all of the process data at the fastest possible sampling rate. In this way, one ensures that the process data required for detection of the abnormal situation is available after its occurrence.

While process historians are available to store large amounts of process data, typical process historians are configured to collect data over long periods of time (e.g., years). As a result, historians are often configured to compress or reduce the collected data to significant extents. For instance, some process measurements may only be polled once per hour. Other measurements may not be collected unless the data value exceeds a deadband or other range. More generally, the manner or arrangement in which process historians store process data may also be unsuitable for monitoring process data generated during a field trial. Further, use of an available historian to store field trial data may be inappropriate, as the capacity of the historian could be quickly exhausted.

For the foregoing reasons, process historians and the data collected thereby are not suitable for process data collection in circumstances where either the cause, timing or effect of the abnormal situation is unknown.

### SUMMARY OF THE DISCLOSURE

In accordance with certain aspects of the disclosure, a number of techniques are disclosed to facilitate the monitoring of the implementation of a process control system and any elements thereof. Such monitoring generally includes or involves process data collection and capture, which may be useful in connection with the development of further aspects or elements of the process control system, such as diagnostic elements. The diagnostic functionality under development or testing may involve the implementation of modules, routines or other logic elements to detect and/or prevent abnormal situations or operation. The techniques disclosed herein may facilitate the development of such modules, routines or other logic elements via the collection of data during field or other testing situations or, more generally, any operational context. The process control systems may thus present large scale data capture requirements, and some aspects of the disclosure and embodiments thereof are directed to, or well suited for, automated or automatic configuration and data archiving, as well as data storage and handling techniques (e.g., buffering) for handling the extensive data involved. The configuration techniques may include automated scanning techniques for identifying or detecting those elements of the process control system for monitoring. The data storage and buffering techniques may include data storage arrangements directed to efficiently handling the process data collected.

### BRIEF DESCRIPTION OF THE DRAWINGS

FIG. 1 is an exemplary block diagram of a process plant having a distributed control and maintenance network including one or more operator and maintenance workstations, controllers, field devices and supporting equipment;

FIG. 2 is an exemplary block diagram of a portion of the process plant of FIG. 1, illustrating communication interconnections between various components of an abnormal situation prevention (ASP) system located within different elements of the process plant;

FIG. 3 is an exemplary user interface display of an abnormal situation prevention (ASP) module having a number of input and output parameters for monitoring operation of the process plant;

FIG. 4 is an exemplary user interface display representation of a process parameter or item hierarchy in which the abnormal situation prevention module of FIG. 3, and any components and parameters thereof, are arranged;

FIG. 5 is a block diagram of a data capture system for monitoring and testing abnormal situation prevention modules and other diagnostic elements in accordance with one aspect of the disclosure;

FIG. 6 depicts an exemplary user interface display generated by the data capture system of FIG. 5 in accordance with one embodiment;

FIG. 7 is a flow diagram of a data collection and management routine implemented by the data capture system of FIG. 5 in accordance with one aspect of the disclosure;

FIG. 8 is a flow diagram of a process parameter selection or identification routine implemented by the data capture system of FIG. 5 in accordance with one embodiment;

FIG. 9 is an exemplary user interface display for manual configuration of the data capture system of FIG. 5 via the selection or specification of process parameters or other items to be monitored by the data capture system of FIG. 5;

FIG. 10 is an exemplary user interface display to facilitate the specification of a number of options to customize or configure the data capture system of FIG. 5 in connection with an automatic backup, or archiving, procedure in accordance with one embodiment;

FIG. 11 is a flow diagram of a backup or archiving procedure implemented by the data capture system of FIG. 5 in accordance with one aspect of the disclosure;

FIG. 12 is an exemplary user interface display generated in connection with a backup or archive operation implemented by the data capture system of FIG. 5 in accordance with one embodiment;

FIG. 13 is a further exemplary user interface display generated by the data capture system of FIG. 5 in connection with the backup or archiving procedure;

FIGS. 14 and 15 are exemplary user interface displays of data structures or formats for storage of process data collected by the data capture system of FIG. 5 in accordance with another aspect of the disclosure and in connection with alternative embodiments;

FIG. 16 is a block diagram depicting a buffering technique for storage of the process data collected by the data capture system of FIG. 5 in accordance with one embodiment;

FIG. 17 is an exemplary user interface display generated by the data capture system of FIG. 5 in connection with an automated scan procedure for configuration of the data capture system in accordance with one aspect of the disclosure;

FIGS. 18 and 19 are flow diagrams of the automated scan procedure implemented by the data capture system of FIG. 5 in accordance with one embodiment;

FIG. 20 is an exemplary user interface display generated by the data capture system of FIG. 5 in connection with the automated scan procedure and, more generally, the configuration of the data capture system in accordance with one embodiment;

FIG. 21 is a flow diagram of a configuration routine implemented by the data capture system of FIG. 5 in connection with the automated scan procedure and, more generally, the configuration of the data capture system in accordance with one embodiment;

FIG. 22 is an exemplary user interface display representation of a process parameter or item hierarchy to be scanned via the automated scan procedure and the data capture system of FIG. 5 in accordance with the exemplary embodiments depicted in FIGS. 20 and 21;

FIG. 23 is an exemplary user interface display representation of a process parameter or item hierarchy resulting from the implementation of the automated scan procedure by the data capture system of FIG. 5 in accordance with the exemplary embodiments depicted in FIGS. 20-22; and

FIG. 24 is an exemplary user interface display representation of a process parameter trend graph generated by the data capture system of FIG. 5 after process data collection in connection with the process parameters monitored via the exemplary user interface display of FIG. 23.

### DETAILED DESCRIPTION

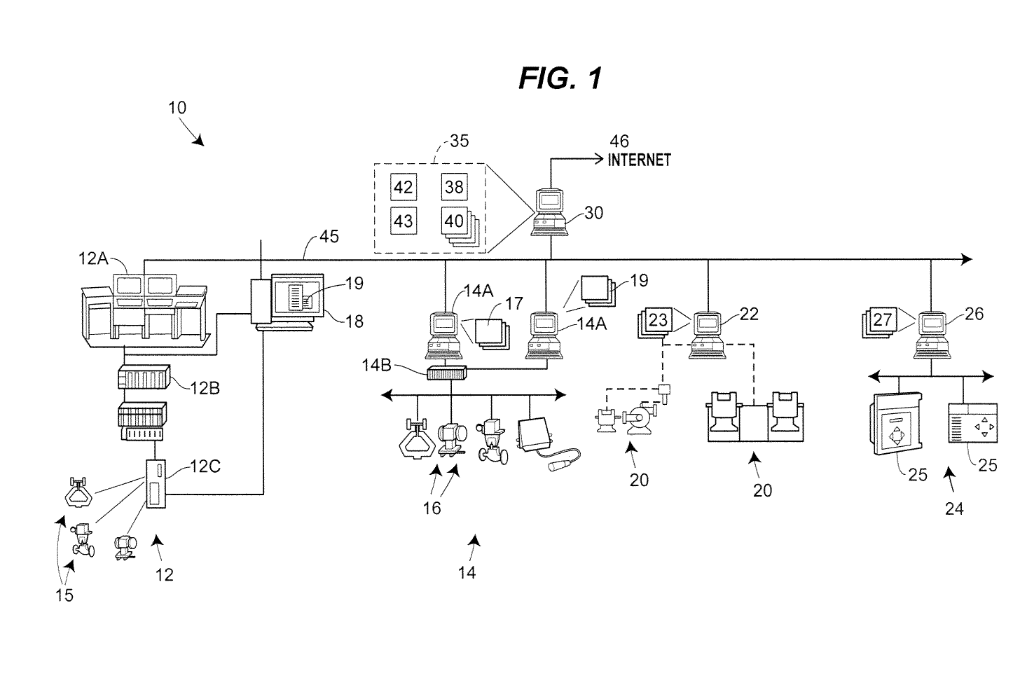

Referring now to FIG. 1, an exemplary process plant 10 in which an abnormal situation prevention system may be implemented includes a number of control and maintenance systems interconnected together with supporting equipment via one or more communication networks. In particular, the process plant 10 of FIG. 1 includes one or more process control systems 12 and 14. The process control system 12 may be a traditional process control system such as a PROVOX or RS3 system or any other control system which includes an operator interface 12A coupled to a controller 12B and to input/output (I/O) cards 12C which, in turn, are coupled to various field devices such as analog and Highway Addressable Remote Transmitter (HART) field devices 15. The process control system 14, which may be a distributed process control system, includes one or more operator interfaces 14A coupled to one or more distributed controllers 14B via a bus, such as an Ethernet bus. The controllers 14B may be, for example, DeltaV™ controllers sold by Emerson Process Management of Austin, Tex. or any other desired type of controllers. The controllers 14B are connected via I/O devices to one or more field devices 16, such as for example, HART or Fieldbus field devices or any other smart or non-smart field devices including, for example, those that use any of the PROFIBUS®, WORLDFIP®, Device-Net®, AS-Interface and CAN protocols. As is known, the field devices 16 may provide analog or digital information to the controllers 14B related to process variables as well as to other device information. The operator interfaces 14A may store and execute tools 17, 19 available to the process control operator for controlling the operation of the process including, for example, control optimizers, diagnostic experts, neural networks, tuners, etc.

Still further, maintenance systems, such as computers executing the AMS application or any other device monitoring and communication applications may be connected to the process control systems 12 and 14 or to the individual devices therein to perform maintenance and monitoring activities. For example, a maintenance computer 18 may be connected to the controller 12B and/or to the devices 15 via any desired communication lines or networks (including wireless or handheld device networks) to communicate with and, in some instances, reconfigure or perform other maintenance activities on the devices 15. Similarly, maintenance applications such as the AMS application may be installed in and executed by one or more of the user interfaces 14A associated with the distributed process control system 14 to perform maintenance and monitoring functions, including data collection related to the operating status of the devices 16.

The process plant 10 also includes various rotating equipment 20, such as turbines, motors, etc. which are connected to a maintenance computer 22 via some permanent or temporary communication link (such as a bus, a wireless communication system or hand held devices which are connected to the equipment 20 to take readings and are then removed). The maintenance computer 22 may store and execute known monitoring and diagnostic applications 23 provided by, for example, CSI (an Emerson Process Management Company) or other any other known applications used to diagnose, monitor and optimize the operating state of the rotating equipment 20. Maintenance personnel usually use the applications 23 to maintain and oversee the performance of rotating equipment 20 in the plant 10, to determine problems with the rotating equipment 20 and to determine when and if the rotating equipment 20 must be repaired or replaced. In some cases, outside consultants or service organizations may temporarily acquire or measure data pertaining to the equipment 20 and use this data to perform analyses for the equipment 20 to detect problems, poor performance or other issues effecting the equipment 20. In these cases, the computers running the analyses may not be connected to the rest of the system 10 via any communication line or may be connected only temporarily.

Similarly, a power generation and distribution system 24 having power generating and distribution equipment 25 associated with the plant 10 is connected via, for example, a bus, to another computer 26 which runs and oversees the operation of the power generating and distribution equipment 25 within the plant 10. The computer 26 may execute known power control and diagnostics applications 27 such as those provided by, for example, Liebert and ASCO or other companies to control and maintain the power generation and distribution equipment 25. Again, in many cases, outside consultants or service organizations may use service applications that temporarily acquire or measure data pertaining to the equipment 25 and use this data to perform analyses for the equipment 25 to detect problems, poor performance or other issues effecting the equipment 25. In these cases, the computers (such as the computer 26) running the analyses may not be connected to the rest of the system 10 via any communication line or may be connected only temporarily.

As illustrated in FIG. 1, a computer system 30 implements at least a portion of an abnormal situation prevention system 35, and in particular, the computer system 30 stores and implements a configuration application 38 and, optionally, an abnormal operation detection system 42, which will be described in more detail below. Additionally, the computer system 30 may implement an alert/alarm application 43.

Generally speaking, the abnormal situation prevention system 35 may communicate with abnormal operation detection systems (not shown in FIG. 1) optionally located in the field devices 15, 16, the controllers 12B, 14B, the rotating equipment 20 or its supporting computer 22, the power generation equipment 25 or its supporting computer 26, and any other desired devices and equipment within the process plant 10, and/or the abnormal operation detection system 42 in the computer system 30, to configure each of these abnormal operation detection systems and to receive information regarding the operation of the devices or subsystems that they are monitoring. The abnormal situation prevention system 35 may be communicatively connected via a hardwired bus 45 to each of at least some of the computers or devices within the plant 10 or, alternatively, may be connected via any other desired communication connection including, for example, wireless connections, dedicated connections which use OPC (or OLE for process control), intermittent connections, such as ones which rely on handheld devices to collect data, etc. Likewise, the abnormal situation prevention system 35 may obtain data pertaining to the field devices and equipment within the process plant 10 via a LAN or a public connection, such as the Internet, a telephone connection, etc. (illustrated in FIG. 1 as an Internet connection 46) with such data being collected by, for example, a third party service provider. Further, the abnormal situation prevention system 35 may be communicatively coupled to computers/devices in the plant 10 via a variety of techniques and/or protocols including, for example, Ethernet, Modbus, HTML, XML, proprietary techniques/protocols, etc. Thus, although particular examples using OPC to communicatively couple the abnormal situation prevention system 35 to computers/devices in the plant 10 are described herein, one of ordinary skill in the art will recognize that a variety of other methods of coupling the abnormal situation prevention system 35 to computers/devices in the plant 10 can be used as well.

By way of background, OPC is a standard that establishes a mechanism for accessing process data from the plant or process control system. Typically, an OPC server is implemented in a process control system to expose or provide process information from, for example, field devices. An OPC client creates a connection to an OPC server and writes or reads process information to or from a field device. OPC servers use OLE technology (i.e., Component Object Model or COM) to communicate with such clients so that the software applications implemented by the clients can access data from the field devices or other process plant equipment.

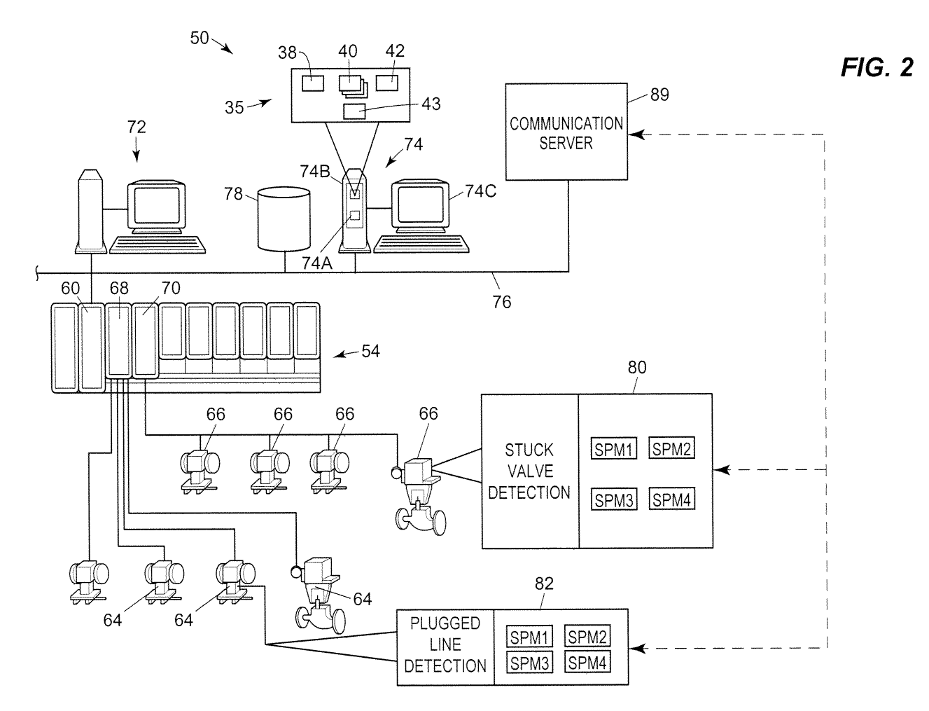

FIG. 2 illustrates a portion 50 of the example process plant 10 of FIG. 1 for the purpose of describing one manner in which the abnormal situation prevention system 35 and/or the alert/alarm application 43 may communicate with various devices in the portion 50 of the example process plant 10. While FIG. 2 illustrates communications between the abnormal situation prevention system 35 and one or more abnormal operation detection systems within HART and Fieldbus field devices, it will be understood that similar communications can occur between the abnormal situation prevention system 35 and other devices and equipment within the process plant 10, including any of the devices and equipment illustrated in FIG. 1.

The portion 50 of the process plant 10 illustrated in FIG. 2 includes a distributed process control system 54 having one or more process controllers 60 connected to one or more field devices 64 and 66 via input/output (I/O) cards or devices 68 and 70, which may be any desired types of I/O devices conforming to any desired communication or controller protocol. The field devices 64 are illustrated as HART field devices and the field devices 66 are illustrated as Fieldbus field devices, although these field devices could use any other desired communication protocols. Additionally, each of the field devices 64 and 66 may be any type of device such as, for example, a sensor, a valve, a transmitter, a positioner, etc., and may conform to any desired open, proprietary or other communication or programming protocol, it being understood that the I/O devices 68 and 70 must be compatible with the desired protocol used by the field devices 64 and 66.

In any event, one or more user interfaces or computers 72 and 74 (which may be any types of personal computers, workstations, etc.) accessible by plant personnel such as configuration engineers, process control operators, maintenance personnel, plant managers, supervisors, etc. are coupled to the process controllers 60 via a communication line or bus 76 which may be implemented using any desired hardwired or wireless communication structure, and using any desired or suitable communication protocol such as, for example, an Ethernet protocol. In addition, a database 78 may be connected to the communication bus 76 to operate as a data historian that collects and stores configuration information as well as on-line process variable data, parameter data, status data, and other data associated with the process controllers 60 and field devices 64 and 66 within the process plant 10. Thus, the database 78 may operate as a configuration database to store the current configuration, including process configuration modules, as well as control configuration information for the process control system 54 as downloaded to and stored within the process controllers 60 and the field devices 64 and 66. Likewise, the database 78 may store historical abnormal situation prevention data, including statistical data collected by the field devices 64 and 66 within the process plant 10, statistical data determined from process variables collected by the field devices 64 and 66, and other types of data that will be described below.

While the process controllers 60, I/O devices 68 and 70, and field devices 64 and 66 are typically located down within and distributed throughout the sometimes harsh plant environment, the workstations 72 and 74, and the database 78 are usually located in control rooms, maintenance rooms or other less harsh environments easily accessible by operators, maintenance personnel, etc.

Generally speaking, the process controllers 60 store and execute one or more controller applications that implement control strategies using a number of different, independently executed, control modules or blocks. The control modules may each be made up of what are commonly referred to as function blocks, wherein each function block is a part or a subroutine of an overall control routine and operates in conjunction with other function blocks (via communications called links) to implement process control loops within the process plant 10. As is well known, function blocks, which may be objects in an object-oriented programming protocol, typically perform one of an input function, such as that associated with a transmitter, a sensor or other process parameter measurement device, a control function, such as that associated with a control routine that performs PID, fuzzy logic, etc. control, or an output function, which controls the operation of some device, such as a valve, to perform some physical function within the process plant 10. Of course, hybrid and other types of complex function blocks exist, such as model predictive controllers (MPCs), optimizers, etc. It is to be understood that while the Fieldbus protocol and the DeltaV™ system protocol use control modules and function blocks designed and implemented in an object-oriented programming protocol, the control modules may be designed using any desired control programming scheme including, for example, sequential function blocks, ladder logic, etc., and are not limited to being designed using function blocks or any other particular programming technique.

As illustrated in FIG. 2, the maintenance workstation 74 includes a processor 74A, a memory 74B and a display device 74C. The memory 74B stores the abnormal situation prevention application 35 and the alert/alarm application 43 discussed with respect to FIG. 1 in a manner that these applications can be implemented on the processor 74A to provide information to a user via the display 74C (or any other display device, such as a printer).

Each of one or more of the field devices 64 and 66 may include a memory (not shown) for storing routines such as routines for implementing statistical data collection pertaining to one or more process variables sensed by sensing device and/or routines for abnormal operation detection, which will be described below. Each of one or more of the field devices 64 and 66 may also include a processor (not shown) that executes routines such as routines for implementing statistical data collection and/or routines for abnormal operation detection. Statistical data collection and/or abnormal operation detection need not be implemented by software. Rather, one of ordinary skill in the art will recognize that such systems may be implemented by any combination of software, firmware, and/or hardware within one or more field devices and or other devices.

As shown in FIG. 2, some (and potentially all) of the field devices 64 and 66 include abnormal operation detection (i.e., advanced situation prevention, or ASP) blocks 80 and 82, which will be described in more detail below. While the blocks 80 and 82 of FIG. 2 are illustrated as being located in one of the devices 64 and in one of the devices 66, these or similar blocks could be located in any number of the field devices 64 and 66, could be located in other devices, such as the controller 60, the I/O devices 68, 70 or any of the devices illustrated in FIG. 1. Additionally, the blocks 80 and 82 could be in any subset of the devices 64 and 66.

Generally speaking, the blocks 80 and 82 or sub-elements of these blocks, collect data, such as process variable data, from the device in which they are located and/or from other devices. Additionally, the blocks 80 and 82 or sub-elements of these blocks may process the variable data and perform an analysis on the data for any number of reasons. For example, the block 80, which is illustrated as being associated with a valve, may have a stuck valve detection routine which analyzes the valve process variable data to determine if the valve is in a stuck condition. In addition, the block 80 may include a set of one or more statistical process monitoring (SPM) blocks or units such as blocks SPM1-SPM4 which may collect process variable or other data within the valve and perform one or more statistical calculations on the collected data to determine, for example, a mean, a median, a standard deviation, a root-mean-square (RMS), a rate of change, a range, a minimum, a maximum, etc. of the collected data and/or to detect events such as drift, bias, noise, spikes, etc., in the collected data. Neither the specific statistical data generated, nor the method in which it is generated, is critical. Thus, different types of statistical data can be generated in addition to, or instead of, the specific types described above. Additionally, a variety of techniques, including known techniques, can be used to generate such data. The term statistical process monitoring (SPM) block is used herein to describe functionality that performs statistical process monitoring on at least one process variable or other process parameter, and may be performed by any desired software, firmware or hardware within the device or even outside of a device for which data is collected. It will be understood that, because the SPMs are generally located in the devices where the device data is collected, the SPMs can acquire quantitatively more and qualitatively more accurate process variable data. As a result, the SPM blocks are generally capable of determining better statistical calculations with respect to the collected process variable data than a block located outside of the device in which the process variable data is collected.

It is to be understood that although the blocks 80 and 82 are shown to include SPM blocks in FIG. 2, the SPM blocks may instead be stand-alone blocks separate from the blocks 80 and 82, and may be located in the same device as the corresponding block 80 or 82 or may be in a different device. The SPM blocks discussed herein may comprise known Foundation Fieldbus SPM blocks, or SPM blocks that have different or additional capabilities as compared with known Foundation Fieldbus SPM blocks. The term statistical process monitoring (SPM) block is used herein to refer to any type of block or element that collects data, such as process variable data, and performs some statistical processing on this data to determine a statistical measure, such as a mean, a standard deviation, etc. As a result, this term is intended to cover software, firmware, hardware and/or other elements that perform this function, whether these elements are in the form of function blocks, or other types of blocks, programs, routines or elements and whether or not these elements conform to the Foundation Fieldbus protocol, or some other protocol, such as Profibus, HART, CAN, etc. protocol. If desired, the underlying operation of blocks 80, 82 may be performed or implemented at least partially as described in U.S. Pat. No. 6,017,143, which is hereby incorporated by reference herein.

It is to be understood that although the blocks 80 and 82 are shown to include SPM blocks in FIG. 2, SPM blocks are not required of the blocks 80 and 82. For example, abnormal operation detection routines of the blocks 80 and 82 could operate using process variable data not processed by an SPM block. As another example, the blocks 80 and 82 could each receive and operate on data provided by one or more SPM blocks located in other devices. As yet another example, the process variable data could be processed in a manner that is not provided by many typical SPM blocks. As just one example, the process variable data could be filtered by a finite impulse response (FIR) or infinite impulse response (IIR) filter such as a bandpass filter or some other type of filter. As another example, the process variable data could be trimmed so that it remained in a particular range. Of course, known SPM blocks could be modified to provide such different or additional processing capabilities.

The block 82 of FIG. 2, which is illustrated as being associated with a transmitter, may have a plugged line detection unit that analyzes the process variable data collected by the transmitter to determine if a line within the plant is plugged. In addition, the block 82 may includes one or more SPM blocks or units such as blocks SPM1-SPM4 which may collect process variable or other data within the transmitter and perform one or more statistical calculations on the collected data to determine, for example, a mean, a median, a standard deviation, etc. of the collected data. While the blocks 80 and 82 are illustrated as including four SPM blocks each, the blocks 80 and 82 could have any other number of SPM blocks therein for collecting and determining statistical data.

Further details regarding the implementation and configuration of ASP systems and components thereof can be found in U.S. Pat. Publ. No. 2005/0197803, now U.S. Pat. No. 7,079,984 (“Abnormal situation prevention in a process plant”), U.S. Pat. Publ. No. 2005/0197806 (“Configuration system and method for abnormal situation prevention in a process plant”), and U.S. Pat. Publ. No. 2005/0197805 (“Data presentation system for abnormal situation prevention in the process plant”), each of which is hereby incorporated by reference for all purposes.

In the ASP systems and techniques described above and in the referenced documents, the SPM (or ASP) blocks 80, 82 may be associated with, or considered components of, one or more ASP modules. While ASP blocks may reside in a field device, where the faster-sampled data is available, ASP modules may reside in a host system or controller. The ASP modules may take data from one or more ASP blocks, and use the data to make a decision about the larger system. More generally, an ASP module may be developed and configured to receive data from one or more function blocks (e.g., ASP blocks) to support diagnostics for each type of field device, instrumentation or other equipment (e.g., valve, pump, etc.). Nonetheless, the function blocks associated with an ASP module may reside and be implemented by devices other than the specific equipment for which it was developed. In such cases, the ASP module has a distributed nature. Other ASP modules may be implemented entirely within one device, such as the process controller 60, despite being directed to diagnostics for a specific field device. In any event, a diagnostics routine or technique may be developed for each equipment type for detecting, predicting and preventing abnormal situations or operation of the equipment (or process). For ease in description only, the term “ASP module” will be used herein to refer to such routines or techniques. An ASP module is therefore responsive to a set of measurements needed to perform the diagnostics, and further includes (i) a set of abnormal conditions to be detected by the module, and (ii) a set of rules, which link a change in the measurements to a corresponding abnormal condition. Furthermore, references to ASP modules in the description of the disclosed techniques to follow are set forth with the understanding that the techniques may be utilized in conjunction with ASP blocks as well.

In some cases, the configuration application 38 or other component of the ASP system 35 may support the development or generation of a template for each ASP module. For example, the configuration and development platform provided by the DeltaV™ control system may be used to create specific instances, or instantiations, of ASP modules from corresponding composite template blocks.

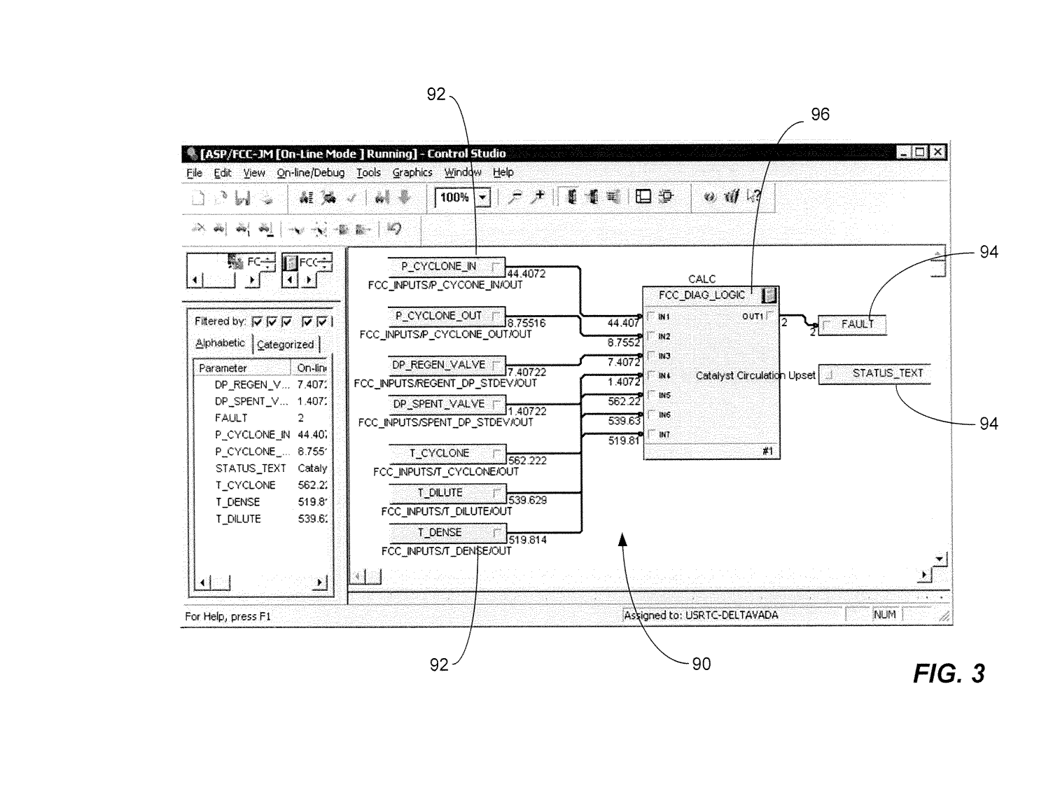

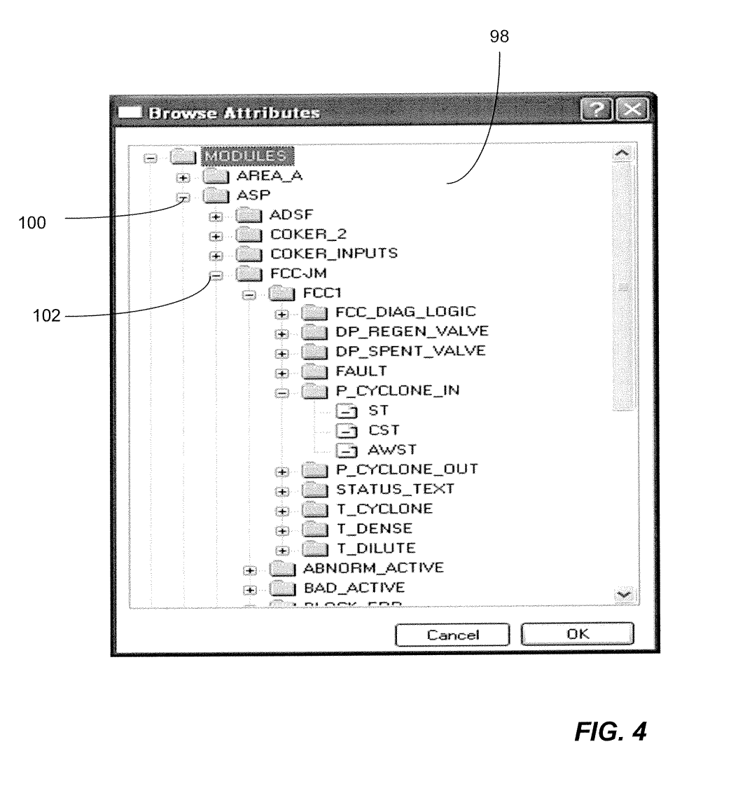

FIG. 3 shows an exemplary ASP module indicated generally at 90 and labeled “FCC-JM.” Generally speaking, the ASP module 90 is configured to perform diagnostic operations on a unit or element of the process plant or process control system. The ASP module 90 may have been created with a configuration user interface provided by the DeltaV™ control system (i.e., Control Studio) and rendered during implementation of the configuration application 38 (FIG. 2). Generally speaking, the configuration application 38 may be used to create both an ASP module template and the ASP module 90. The ASP module template defines the process variables and detection logic, and the ASP module 90 is configured by assigning the process variables to specific parameters (i.e., measurements) of the process. Instantiation of the ASP module 90 may also specify tuning and other parameters. As shown after configuration, the ASP module template may be instantiated as the ASP module 90, which may be assigned a unique name, such as FCC1 (see also FIG. 4). Inputs 92 to the ASP module 90 may constitute the process measurements relied upon in the diagnostics routine or technique of the ASP module 90, while each output 94 of the ASP module 90 is a status indication of present operation, specifically whether operation is normal or abnormal (i.e., whether an abnormal situation has been detected or predicted). Here, the ASP module template FCC1 is shown after instantiation as the ASP module 90 in a run-time, or on-line, environment in which current data and other values for the process measurements and status indications are depicted. To that end, instantiation includes specifying process parameters for seven different measurements that constitute the inputs 92 to the ASP module 90, including, for example, P_CYCLONE_IN (e.g., an inlet pressure) and T_CYCLONE (e.g., a temperature). The outputs 94 generated by the ASP module 90 indicate the fault or abnormal situation detected, both numerically (i.e., FAULT) and textually (STATUS_TEXT), which may indicate the name of the abnormal situation detected. Each of the seven inputs 92 feeds into a calculation/logic block 96, which performs the diagnostics logic, in order to determine the current state of the system. The calculation/logic block 96 for this ASP Module 90 may perform any logic sequence and/or combination of calculations of any desired type.

More generally, the ASP module 90 need not be limited to the form shown in FIG. 3, but rather may have any number of input parameters, output parameters, and calculation or logic elements or aspects, connected, organized or implemented in any desired arrangement or fashion.

FIG. 4 depicts a portion of an OPC hierarchy indicated generally at 98 and having the exemplary ASP module 90. The OPC hierarchy 98 is a tree-based organizational structure to define the modules, nodes and other elements of the process control system. In this partial view, a group of ASP modules are revealed via selection of an ASP expansion icon 100. The ASP module 90 shown in FIG. 3 (FCC-JM) may then be revealed or disposed within the arrangement as one of several ASP modules. The components or items of the ASP module 90, such as the function blocks and associated process parameters, are shown via selection of a further expansion icon 102. Specifically, the inputs, outputs, and calculation/logic block of the ASP module 90 appear as items that, in turn, can be selected for further expansion, viewing, etc.

In operation, the data structure underlying the OPC hierarchy 98 may be accessed to obtain process data and other information from the items in the various levels of the tree. For example, the OPC hierarchy 98 may be established and maintained by an OPC server, such as DeltaV™, and any third-party OPC client can obtain the data by reading or accessing the hierarchy items.

ASP Module Development and Testing

The development of ASP functionality through, for example, the ASP module 90, typically requires multiple stages, involving design and development steps as well as testing of prototypes in field trials. During design and development, the process measurements relevant to the ASP functionality are determined. Then the process measurement data may be analyzed to determine the changes in the process measurements that may be indicative of an abnormal situation. Following that determination, the calculations and logic necessary to detect those changes are specified. Typically, these determinations and development stages are revisited a number of times to make adjustments suggested by testing of prototypes in field trials. The field trials therefore provide for more robust and reliable ASP functionality.

During the prototyping and field trial stages of ASP module development, the relevant (and potentially relevant) process data is logged or otherwise collected for later analysis. When the prototype ASP module does not work correctly, the process data provides a mechanism for determining how the calculations, logic, and/or input parameters should be modified. Through multiple iterations of such testing and data logging, the ASP module is refined to accurately detect a specific abnormal situation.

Process Data Collection, Storage and Backup

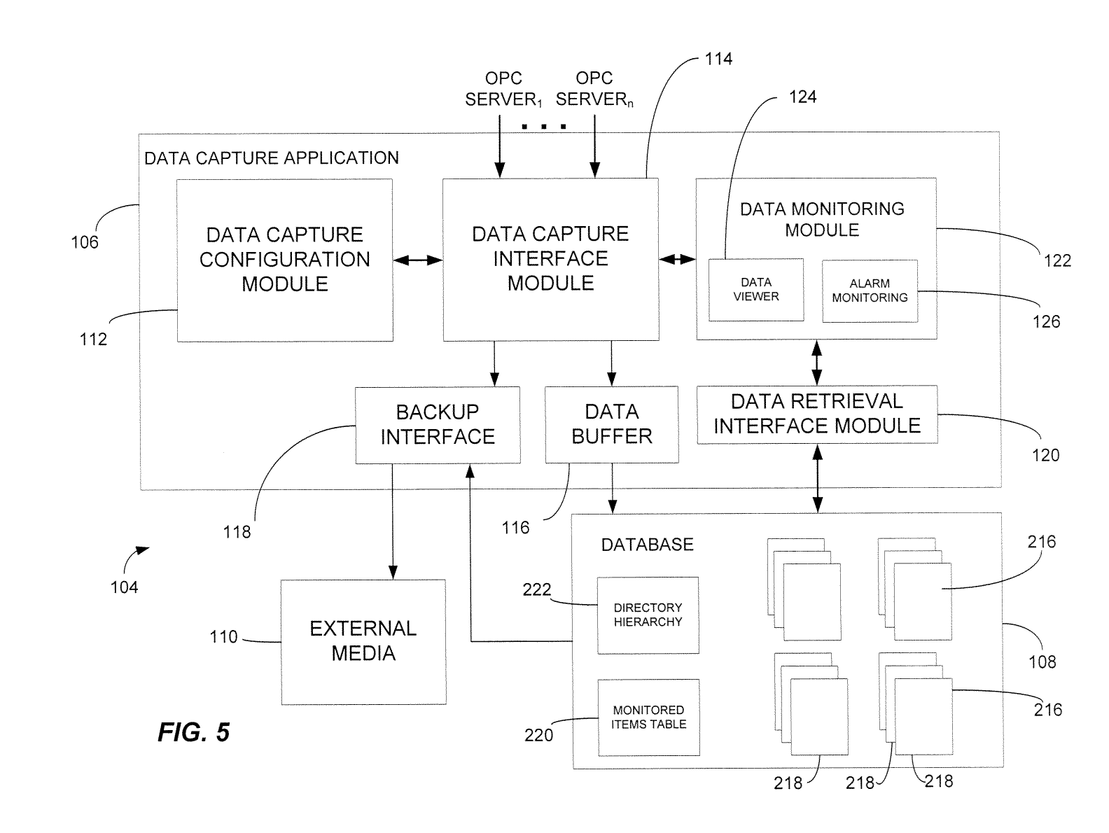

FIG. 5 is a block diagram of a system generally indicated at 104 and adapted for process data collection, storage and backup, to support the development of ASP modules and other diagnostics. The system 104 includes a data capture application 106, a database (or database management system) 108, and external data storage media 110. The data capture application 106 may constitute or include an OPC client configured to communicate with any number of OPC servers (i.e., OPC server₁ through OPC serverₙ), such as one or more DeltaV™ servers. More generally, the data capture application 106 may communicate with any data source to obtain process data for collection and storage, and is not limited to communication through an OPC interface. Any communication protocol may be used.

The data capture application 106, or any portion thereof, may correspond with, or be integrated to any desired extent, with one or more of the applications 38, 40, and 42, described above. As a result, the data capture application 106, or any technique or routine implemented thereby, may form a part of, or be otherwise integrated with, a process control system. However, in some cases, the configuration of the data capture application 106 as a stand-alone application apart from the process control system and its applications may be desirable for a number of reasons. For example, a stand-alone data capture application may provide flexibility and clarity in selecting process parameters for monitoring. Furthermore, a stand-alone data capture application may more easily present one or more dedicated user interface displays to detect alarming and other information during field trials. Such dedicated displays may help avoid confusion for control system operators that would otherwise view the field trial data in the same user interface displays used for actual process control. In any event, the system 104, the data capture application 106, and any component thereof, may be configured to communicate with the process plant, the process control network, the process control system, etc., via any desired mechanism, medium and technique (e.g., Ethernet, wireless, etc.), including any one or more of the manners described above in connection with the applications 38, 40, 42, and in the referenced documents. To that end, the same or similar communication techniques may be utilized.

The data capture application 106 includes a number of components or modules directed to configuring and using the system 104 to capture process data for diagnostics development and testing, as well as other process control system monitoring. A data capture configuration module 112 is generally directed to supporting user configuration of the operation of the system 104 and the application 106 through a number of user interfaces described below. The data capture configuration module 112 may also include functionality for automated configuration of the application 106. Generally speaking, the configuration module 112 supports the process of identifying or selecting the process parameters for which process data will be logged, captured and stored.

Once the process parameters have been identified or selected, a data capture interface module 114 may be executed to implement a number of data collection, handling and other processing routines. The data capture interface module 114 may include or communicate with an OPC or other interface to facilitate the initial gathering and capture of the process data. The data capture interface module 114 may also control the processing or handling of the process data after it has initially been gathered. Specifically, the data capture interface module 114 may direct the operation of a data buffer 116 and its communications and other interactions with the database 108. The data capture interface module 114 may also control a backup interface 118 generally directed to facilitating the further storage of process data in the external media 110. Further details regarding the operation of the data capture interface module 114, the data buffer 116, and the backup interface 118, are provided below. Generally speaking, however, the operation of the data buffer 116 and the backup interface 118 may be automated to any desired extent, such that manual steps taken by an operator during the data collection procedure are kept to a minimum.

The data capture interface module 114 or, more generally, the data capture application 106, may control the storage of process data in the database 108. Alternatively or additionally, the database 108 may include dedicated database management functionality. In either case, the database 108 may be automatically and periodically maintained via a number of data management storage techniques and operations, as well as data purge operations, all of which are described below.

At any point during implementation of the data capture application 106, the process data collected in the database 108 or stored elsewhere in the system 104 may be accessed for analysis by a user. Such access may be desirable to view data trends or snapshots of specific process parameters involved in, or related to, an abnormal situation. To this end, the data capture application 106 may include a data retrieval interface module 120 in communication with the database 108 as shown in FIG. 5. Alternatively or additionally, the data retrieval interface module 120 may communicate with the external media 110 either directly or indirectly. The data retrieval interface module 120 provides the stored process data to a data monitoring module 122 configured to include a data viewer 124 and an alarm monitoring component 126.

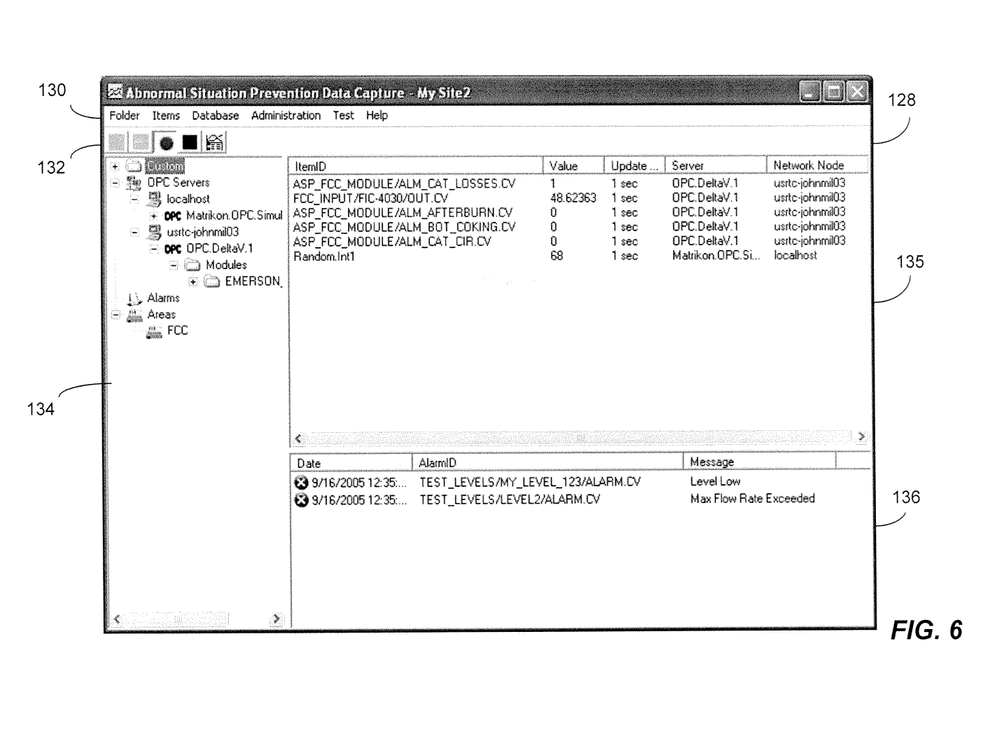

During operation, the data capture application 106 may generate a user interface in which a number of display windows may be rendered and dedicated to supporting the functionality of the modules of the application 106. The user interface may include a main display window from which a user may access the display windows dedicated to the modules. FIG. 6 depicts an exemplary main display window 128 having a menu bar 130, a toolbar 132, and display panels 134-136. The menu bar 130 and toolbar 132 may be used to initiate the implementation and access the features of the modules of the application 106. The display panel 134 provides a hierarchal or tree-based view of the process items and parameters monitored by the application 106. For example, the hierarchy may list a number of ASP modules, such that the panel 134 identifies a number of OPC items of the ASP modules for which process data will be collected. The display panel 135 depicts a detailed list of process parameters where items associated with an item selected in the panel 134, while the display panel 136 shows a list of all active alarms in the items (e.g., ASP modules) being monitored.

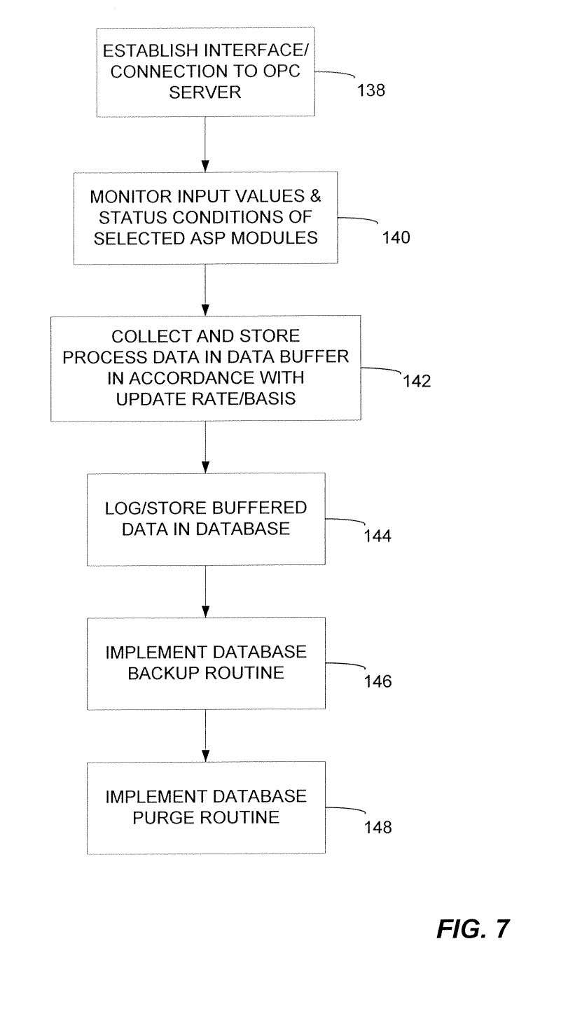

FIG. 7 is a flow diagram depicting implementation steps and routines taken during operation of the system 104 and execution of the data capture application 106. Generally speaking, the implementation steps and routines are directed to implementing data collection and processing in a runtime environment, such as during a field trial or test of a diagnostics or other element of the process control system. Initially, the system 104 establishes an interface or connection to a data source, such as an OPC server in a block 138. In some cases, multiple communication connections may be established and maintained, and may involve different communication interfaces or protocols. In other cases, an interface or connection is not necessary, because, for example, the system 104 is integrated with the process control system or other source of process data. In any event, the data capture interface module 114 or other component of the system 104 next monitors in a block 140 the process parameters associated with the diagnostic functionality being tested. For example, the block 140 may involve monitoring the input values and status conditions of a number of ASP modules that have been selected for testing.

As described below, the process data associated with the monitored process parameters is gathered or collected at certain points during the monitoring process. The frequency and/or circumstances under which data is collected may be specified via a configuration of the data capture application 106, the details of which are also described further below. In some cases, and as shown in FIG. 7, the process data may be collected in a block 142 in accordance with an update rate and/or update basis, either of which may be user-specified. The block 142 may also implement a data storage step involving the data buffer 116. Eventually, the collected process data is logged or stored in the database 108 during implementation of a block 144.

From time to time, database backup and purge routines 146 and 148 may also be implemented during the runtime environment, as warranted. Alternatively or additionally, the database backup and purge routines 146 and 148 may be implemented upon user request, or in accordance with user-specified configuration criteria. In any event, the initiation of the routines 146 and 148 may be automated to any desired extent. Furthermore, the routines implemented by the blocks 146 and 148 may be executed any number of times at varying points in the flow shown in FIG. 7.

These and other aspects of the routines 146 and 148 and other elements of the disclosed techniques may facilitate data collection and monitoring of an on-line process in a data-intensive manner. As long as the process remains on-line, process data continues to be generated. In some situations, such as field tests of ASP modules, the continued collection of process data from an on-line process over the entire duration of the tests (e.g., weeks, if not months) at time intervals suitable for development, analysis and qualification of the ASP module, would otherwise overwhelm the data storage capabilities of the process control system (e.g., the data historian). In contrast, the disclosed techniques support continued collection for all of the process parameters relevant to the ASP or other module being monitored or developed to handle the ongoing generation of process data from the operation of the process.

In some cases, the backup routine 146 may be automatically implemented in connection with the purge routine 148, and vice versa. For instance, initiation of the purge routine 148 may cause the data capture application 106 to facilitate a backup to the external media 110. In the exemplary embodiment shown in FIG. 5, the backup interface 118 may be directed by the data capture interface module 114 to retrieve data from the database 108 and pass the retrieved data to the external media 110. Similarly, initiation of the backup routine 146 may cause the data capture application 106 to implement the purge routine 148. To that end, the data capture interface module 114 or other component of the data capture application 106 may send a command or signal to the database 108 with an indication of instructions for the purge operation. Alternatively or additionally, the database 108 may include functionality to implement these steps and routines on an independent basis.

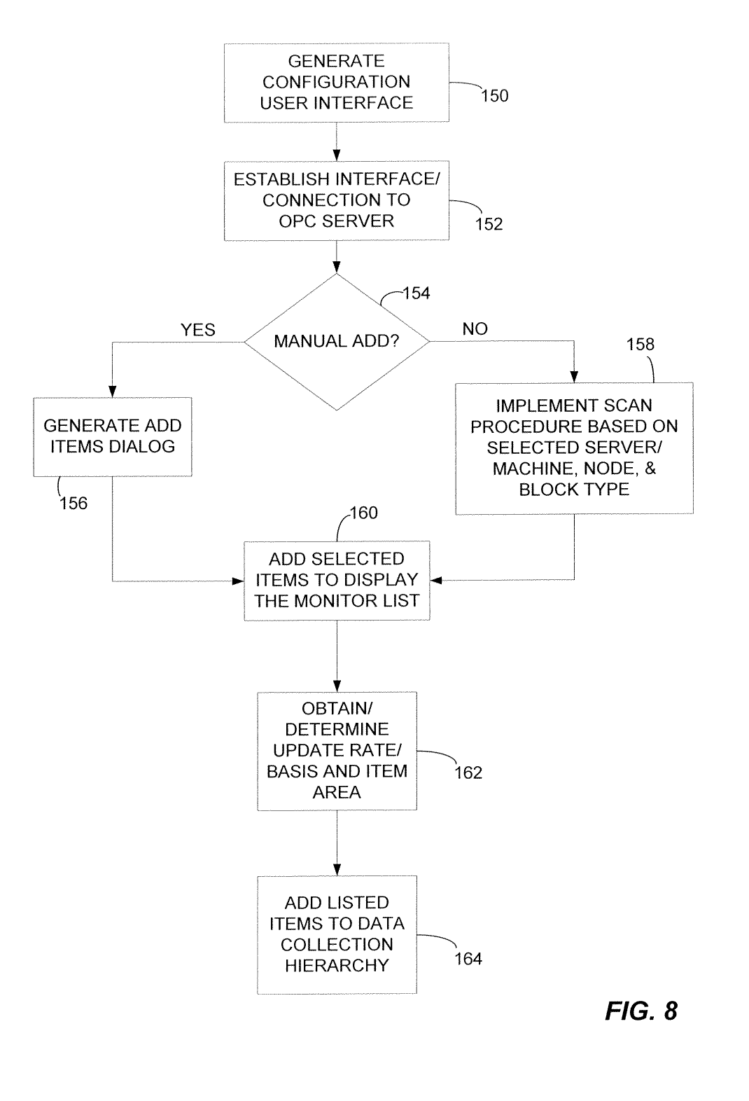

With reference now to FIG. 8, the manner in which the process parameters (e.g., input values and status conditions) are selected or determined for monitoring is now described in connection with one embodiment of the data capture application 106 (FIG. 5) that provides both manual and automated procedures. Specifically, the data capture configuration module 112 (FIG. 5) supports multiple ways in which a user may select or determine the process parameters to be monitored. While each way is automated to a certain extent, the procedure referred to herein as “automated” involves the implementation of a scanning procedure that automatically determines the process parameters associated with the ASP modules installed or otherwise present in the systems (e.g., OPC servers) being monitored. In this way, a user need not manually search for, and select, each of the process parameters to be monitored in a field trial or other temporary or permanent installation. Nonetheless, users are provided the option to supplement, substitute or not utilize the results of the scan through the manual item selection procedure described below.

In the embodiment shown in FIG. 8, both the manual and automated selection routines are driven by, or initiated from, a common user interface. Specifically, a configuration user interface display is generated in a block 150 to present a user with a number of configuration options. This user interface display may be rendered as a result of the execution of the data capture configuration module 112 (FIG. 5). However, any number of the components of the data capture application 106 may also be executed and involved in connection with the selection of process parameters for monitoring. For instance, the data capture interface module 114 may establish an interface or connection to one or more OPC servers in a block 152 to support communications during the configuration procedure. Moreover, the data capture interface module 114 and other components of the data capture application 106 may be implemented and involved in the rendering of the display window 128 (FIG. 6). Via that user interface and, specifically, the menu bar 130 or tool bar 132, a user may initiate a selection procedure. For instance, the “Items” menu of the menu bar 130 may present the user with an opportunity to select the manual procedure or the automated procedure. Alternatively or additionally, the menu bar 130 may provide an option to generate a dialog window generally directed to the selection procedure, and which provides an opportunity to select between the manual and automated options. In any case, a decision block 154 passes control to either a block 156 or a block 158 depending on the user selection. If the manual procedure is selected, the data capture application 106 generates a block 156 an “Add Items” dialog window to facilitate the selection of process parameters (e.g., OPC items). Otherwise, the data capture application 106 implements a scan procedure in a block 158 based on a number of preferences, settings or options that customize or focus the scan. Execution of the block 158 may also include or involve the generation or rendering of one or more user interface displays or dialog windows to facilitate the selection of such preferences, settings or options. Further details regarding the operation of the manual and automated procedures are provided below in accordance with the exemplary embodiments.

After implementation of one or both of the selection procedures, control passes to a block 160 that adds any selected items or process parameters to a list or other identification of items or parameters to be monitored. The selected items or process parameters may be listed or identified in a display window that provides a user with an opportunity to remove or modify the list. For example, each listed item may be modified or customized in a block 162 via specification of an update rate or update basis, as well as an Area. The Area parameter supports the classification of process parameters according to the various areas, units or divisions of the plant. Using the classification, it is possible to view, plot, export, or backup process data corresponding to a single, specified area, rather than an entire database. The update rate and update basis determine the frequency and circumstances under which the process data for a process parameter or item being monitored is captured or gathered. After finalizing and customizing the list of items to be monitored, the user may elect to exit the configuration procedure by electing in a block 164 to add the listed items to a data collection hierarchy. In so doing, a number of ASP modules or other diagnostics components can be monitored for testing, etc.

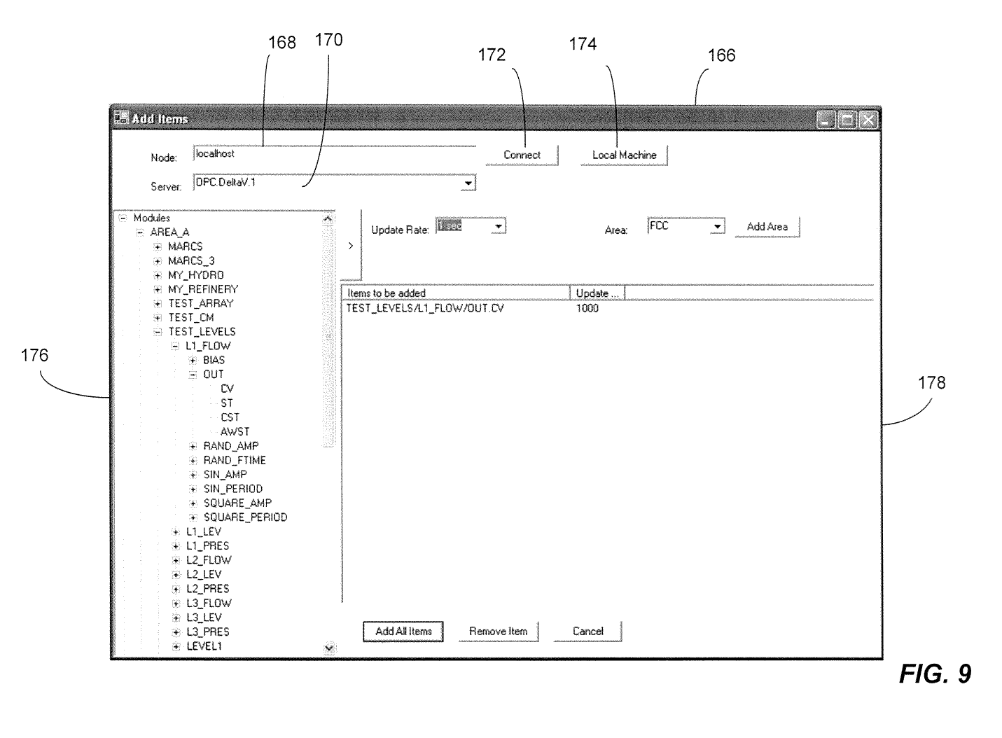

FIG. 9 depicts an exemplary dialog window 166 for facilitating the manual procedure for adding items for monitoring. The window 166 includes a data field 168 for specifying a node of the process control system or network, as well as a data field 170 for specifying an OPC server or other data source. The dialog window 166 may also support the initiation of the interface or connection to the data source via user selection controls (or buttons) 172 and 174. The exemplary dialog window 166 also includes a panel 176 to provide a hierarchical or tree view of the modules within a selected node or server. Selection of one of the modules displayed in a panel 176 may reveal through expansion a number of process parameters or other items available for monitoring. Selection of a process parameter or item in the panel 176 may then cause a panel 178 to reflect the selection, listing and identification of the process parameter or item with other items previously selected. Subsequently, the user may also select one of the parameters or items listed in the panel 178, which then provides an opportunity to specify the update rate, area and other characteristics of the monitoring.

The alternative to using the dialog window 166 may involve, as indicated above, and automated scan of the process parameters or items available for monitoring. Various scan procedures or methods may be used, as desired. For example, the OPC Automation 2.0 interface, specified by the OPC Foundation (www.opcfoundation.org) in its Data Access Automation Interface Standard, version 2.02, provides standard methods to browse the contents of an OPC server. These or other browser methods may be used to automatically traverse the OPC hierarchy. For further information regarding these and other techniques, please refer to the applications referenced above. In some embodiments, however, the scan procedure may be based on a format or configuration of ASP modules designed to provide an indication to a scanner or other automated technique. Further details regarding such scan procedures are set forth below.

Automated Backup and Other Archiving Procedures

Once a number of process parameters or items have been identified or selected for monitoring, the data capture application 106 (FIG. 5) may be deployed in, for instance, in a field trial or other context in which data gathering is desired. Often times, the data capture application 106 is executed during a time period in which all available data should be stored. In that way, if an abnormal situation occurs, a designer or developer of an ASP module or other diagnostics component will be able to subsequently analyze the data captured by the application 106 to determine or develop any improvements to the ASP module or diagnostics. During the field trial, circumstances may warrant gathering much more data than would normally be stored in the plant historian. For example, a typical field trial scenario may involve monitoring hundreds of different OPC items at a sampling rate of once per second. Data gathering under such circumstances would generate an estimated 300 MB of data per day. If the ASP field trial lasts for one year, the total amount of data collected would be 110 GB. In these and other circumstances, storage of the collected data outside of the database 108 (FIG. 5) may be desirable or necessary. Otherwise, in some cases, implementation of the application 106 may result in data storage errors or problems due to lack of storage capacity of a, for instance, hard drive. Data storage outside of the database 108 may also provide a convenient mechanism for providing or transmitting the collected process data to a third party or system for analysis while the field trial is ongoing. Such data storage, as described below, may include or involve backing up (or otherwise copying) the process data to a CD or DVD (or other optical disk) as the external media 110 (FIG. 5). Practice of the disclosed techniques, however, is not limited to any media type, and may involve more than one media type, as desired.

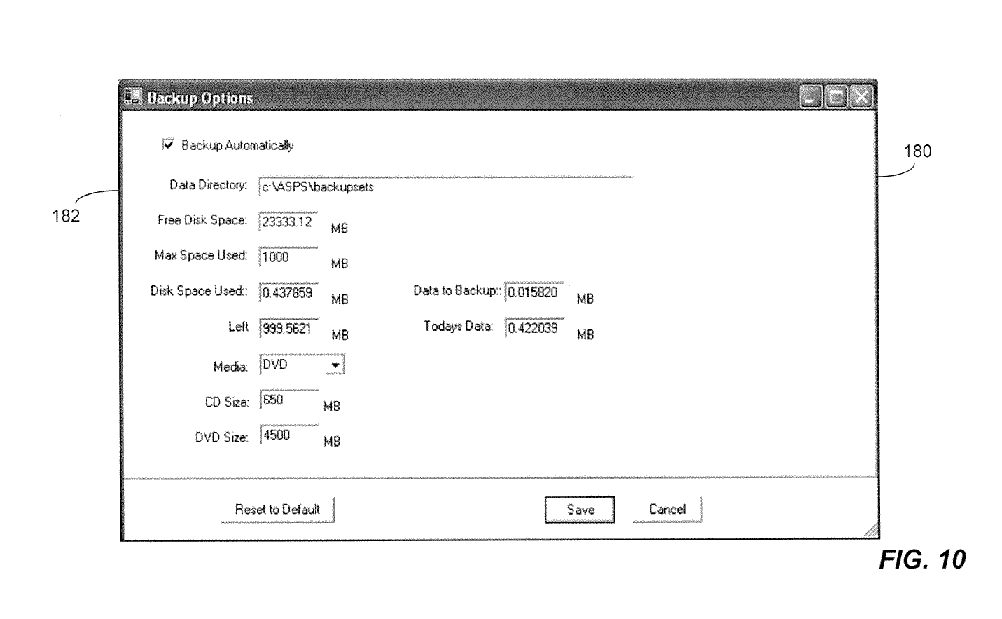

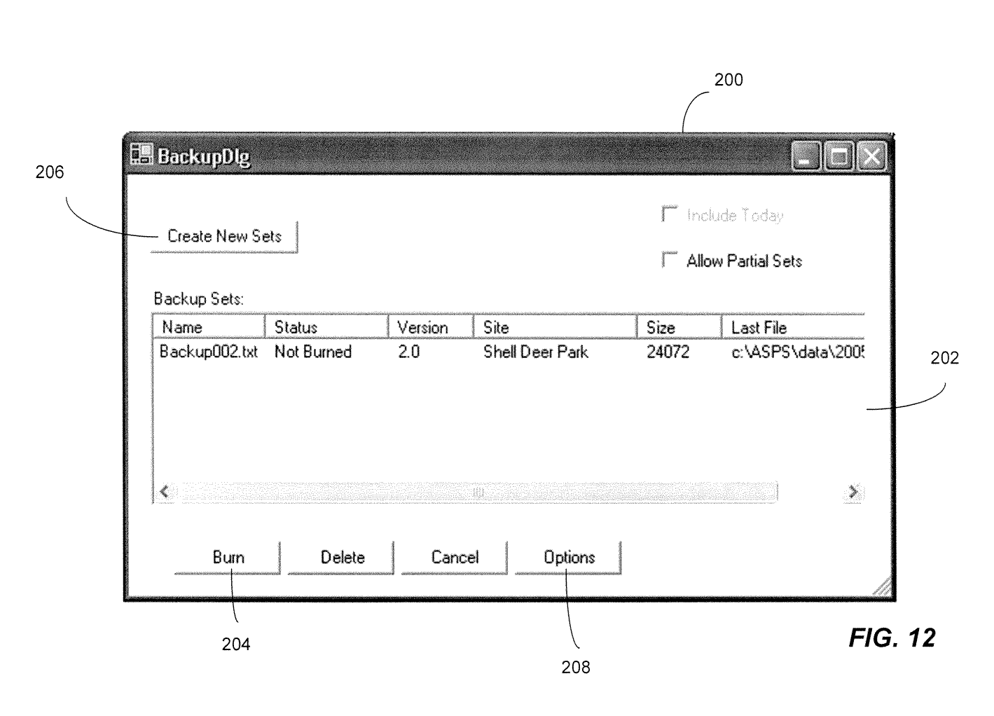

FIG. 10 shows an exemplary dialog window 180 that may be generated or rendered by the data capture application 106 to facilitate customization of a number of its procedures, features, etc., including a backup procedure. The data capture interface module 114 may generate the dialog window 180 in response to user selection of an “Options” or other command made available via the menu bar 130 of the display window 128 (FIG. 6) for customization of the application 106. Alternatively or additionally, the dialog window 180 may be generated during (or in connection with) the implementation of the backup (or other) procedure via selection of an “Options” or other command made available thereby. Please see, for example, FIG. 12.

The display window 180 may include a panel 182 directed to user specification of options, features, etc. available during an automatic, or periodic, backup procedure. The exemplary options panel 182 shown in FIG. 10 may be used to configure the backup procedure in preparation for future automatic backups. Configuration may, in some embodiments, may involve specifying the condition(s) under which an automatic backup is triggered or periodically initiated. More generally, the panel 182 configures the operation of the automatic backup procedure. For instance, a user may specify the maximum amount of hard drive space to be used, a data location or directory for the database 108, and the media type (e.g., CD) for the backup. The options panel 182 may also include a number of additional data fields for displaying information regarding the database 108 and the process data stored therein, such as the amount of free disk space available and the amount of data stored in a particular time period or session (e.g., day).

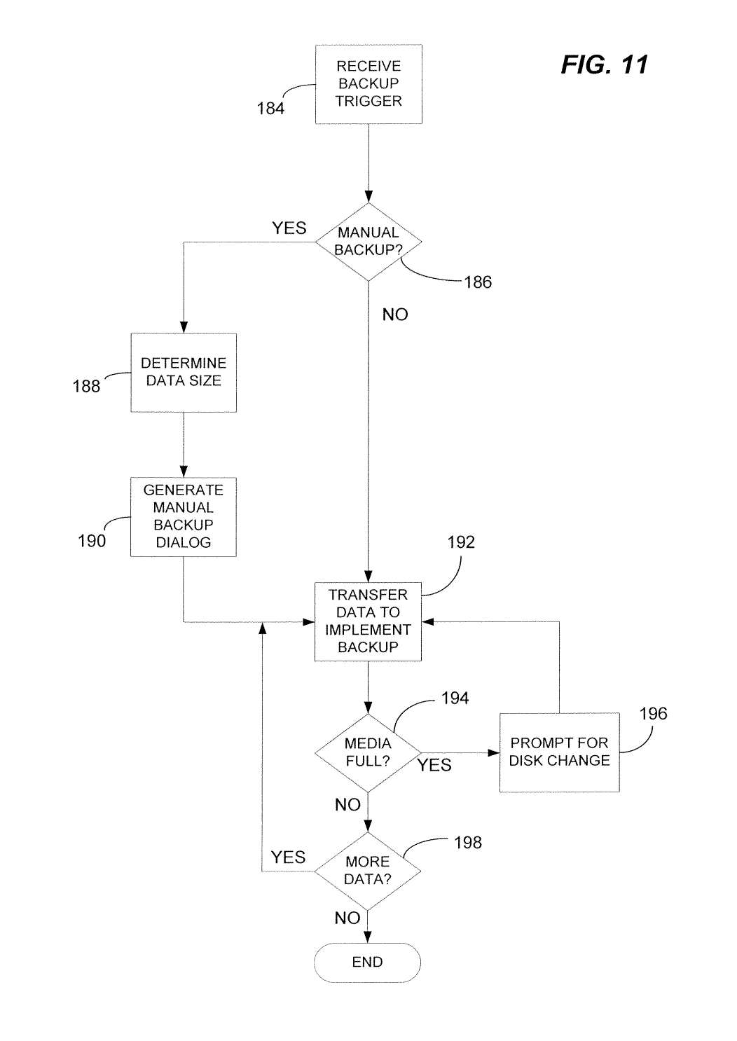

At this or any subsequent point during operation, a user may place one or more storage disks (or other containers) of the selected media type (e.g., CD, DVD, etc.) in a drive or other repository (e.g., disk carousel, etc.). When enough data has been collected by the application 106 (as specified via the options panel 182 or available on the disk, e.g., 640 MB for a CD), the application 106 begins the backup procedure to the external media 110. When the backup is complete, the disk may be ejected or otherwise moved, and the user may be prompted to take any one or more of a number of actions related to the backup procedure, including, for example, labeling the ejected disk and insertion of a new disk(s). Further information regarding the procedure is set forth below in connection with the exemplary flow of FIG. 11.

FIG. 11 is a flow diagram of steps taken by the data capture application 106 when implementing a backup or archive procedure in accordance with one embodiment. The implementation of the backup or archive procedure may be triggered in a number of different ways. For instance, an automatic backup may be triggered by an elapsed time, data size threshold, available space (e.g., disk space), or user request. The data size threshold may relate to either the size of the database or the storage capacity of the external media. The characteristics of these triggers (e.g., threshold values) may be specified via the dialog window 180. In any case, a backup trigger is received in a block 184, after which it is determined whether automatic backups have been enabled. To that end, a decision block 186 determines whether the current backup trigger has called for a manual backup, in which case a block 188 determines a data size of the backup, and a dialog window is generated in a block 190 to facilitate the procedure. If an automatic backup is to be performed, control passes to a block 192 to begin the transfer of process data from the database 108 (FIG. 5) to the external media 110 (FIG. 5). A manual backup may also begin in the block 192 once the parameters and other details thereof have been specified.

At any time during the backup procedure, a decision block 194 may determine whether the external media 110 is full. And if so, control passes to a block 196 that prompts the user for a disk (or other media) change via the user interface display generated by the data capture application 106. Otherwise, control may pass to a decision block 198 to determine whether further data from the database is to be transferred. The steps associated with the blocks 194 and 198 may be implemented at any point in the backup procedure, and may constitute routines that are triggered independently of the remainder of the backup procedure.

FIG. 12 shows a display window 200 associated with a manual backup procedure in accordance with one embodiment. The display window 200 may be launched as a result of selection of a command made available via the menu bar 130 of the display window 128 (FIG. 6). More generally, the display window 200 may be generated or rendered in any manner, including automatically, given a trigger of the data capture application 106. For instance, the amount of process data stored in the database may reach or exceed a threshold amount, at which point the display window 200 is generated to prompt the user to implement a backup or archive operation.

Regardless of the circumstances of the launch of the window 200, the data capture application 106 may evaluate the size or amount of the process data currently stored in the database 108 for comparison with the capacity of the selected backup media (e.g., 640 MB for CD-ROM and 4.5 GB for DVD). As a result of this comparison, the display window 200 determines a number of backup sets or archive units to cover (or otherwise accommodate) the stored data. For example, if there is 1.8 GB of process data stored in the database 108, and selected media type is CD-ROM, then the display window 200 will list the three backup sets in a dialog window 202. Each backup set may contain the data for a given period of time. In this way, each backup set may be dedicated or directed to, for instance, archiving data for a certain number of days. The user may then select one of the listed backup sets in the window 202, and click a Burn button 204 to begin the process of copying process data from the specified time span to an available disk (i.e., a CD or DVD inserted in a disk drive).

The display window 200 may also include or present customization options to allow a user to specify or create new backup sets to replace or augment those sets established automatically by the data capture application 106. To that end, the display window 200 includes a button 206 that may be selected to initiate the generation of a further dialog window that prompts the user to establish a new backup set through specification of various parameters to define the set. Further customization alternatives for the backup procedure may be reached via selection of an options button 208, the selection of which may generate the panel 182 (or dialog window 180) of FIG. 10.

In some embodiments, data may not be immediately purged from the database 108 or hard drive(s) on which the database 108 is recorded. Rather, a data purge operation may be implemented at a subsequent time once a maximum storage capacity is reached. In any event, the data capture application 106 may enable a user to manually initiate a data purge operation at any desired time.

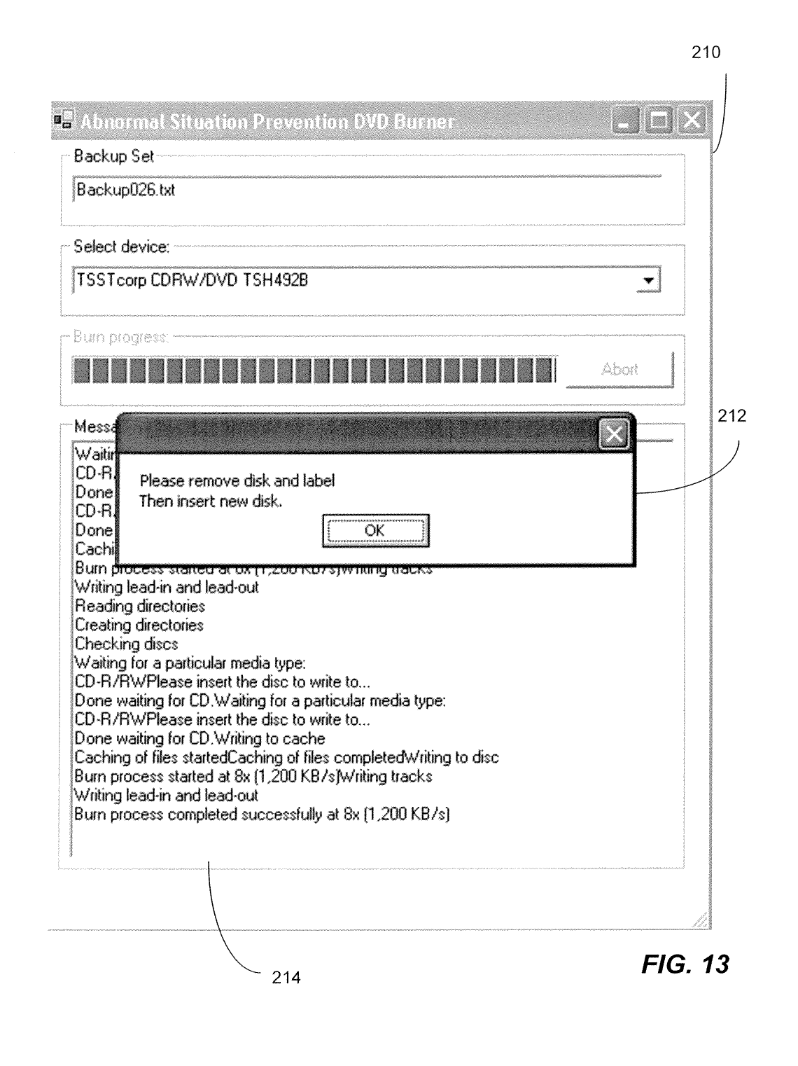

FIG. 13 depicts a display window 210 that may be generated or rendered in connection with the implementation of an automatic backup or archive operation. As described above, the automatic backup or archive operation may include or involve prompting a user to remove or insert storage discs, as necessary. To that end, the display window 210 may include a pop-up window 212 as an alert to the user. The display window 210 may also include a dialog panel 214 in which textual and other messages may be related to the user to convey the status and history of the backup operation. Other portions of the display window 210 may be directed to identifying the current backup set being burned or otherwise copied or archived, as well as the device being used to implement the copying.

Database Storage and Buffering Techniques

With reference again to FIG. 5, the database 108 may store the captured process data in any desired format, arrangement or data structure. As a result, the database 108 may, in fact, include a number of data structures or databases disposed in a centralized, distributed or other fashion. The database 108 may, for instance, include any number of separate and distinct files or other components, as described below. Generally speaking, however, the database 108 may include a list or identification of process parameters or items being monitored by the data capture system 104 and, for each monitored item, a number of tables of measured values for each item stored in conjunction with an identification of the time at which the measurement occurred, and the quality of that measurement. The list of process parameters may identify the parameters by, for example, an identification number, parameter name, OPC item ID, and OPC server (or other data source), or via any other desired naming convention.

While these lists and, more generally, the database 108, may be structured and managed in accordance with relational database techniques commonly utilized in connection with commercially available database management systems (e.g., SQL Server and Oracle), the large amounts of process data collected via the techniques disclosed herein may benefit from a storage or database format having structural and other characteristics adapted to the process data collection context as described below. Generally speaking, the disclosed format can be easily expanded to include additional process parameters or items, and is well suited for capturing large amounts of data quickly and efficiently. The disclosed format is also well suited for accessing large amounts of data for a limited or small number of process variables such that, for example, the collected data for five process parameters may be easily displayed despite the, for example, tens or hundreds of thousands of samples of each variable. The disclosed format is still further well suited for copying subsets of the collected process data to external media for the reasons described above. For similar reasons, the disclosed format is well suited for occasionally or periodically purging, copying or otherwise extracting subsets of the collected process data to, for instance, generate trend and other views of a process data measurement over time.

Generally speaking, the disclosed data storage format includes a data structure that utilizes a number of separate and distinct files arranged in a data file hierarchy. As described below, data storage via the disclosed arrangement and technique reduce, minimize, if not eliminate, the need for complex database management techniques, such as indexing, to support large, multi-variable tables of data.

In the exemplary embodiment shown in FIG. 5, the database 108 includes a plurality of separate file groups 216, each of which includes a number of individual data files 218 as described below. The database 108 further includes a list or table 220 of items monitored by the data capture system 104, as well as a file 222 storing file directory or hierarchy information for the data files process parameters stored in the database 108.

The database file structure in accordance with one aspect of the disclosure is now described in greater detail. Generally speaking, the hierarchy information defines the separate file groups 216. In one embodiment, the definition of the groups corresponds with a file folder arrangement, such that the files 218 within each group 216 are collectively disposed in respective file folders. The disposition of the files in folders may reflect a physical storage arrangement in which the data in each file is located within a memory, a memory space or memory area dedicated to a folder. Alternatively (or additionally), the arrangement may be representative of an association of such data with a folder. The association may be set forth in a file allocation table or other data set directed to organizing and/or managing the data files stored in the database.

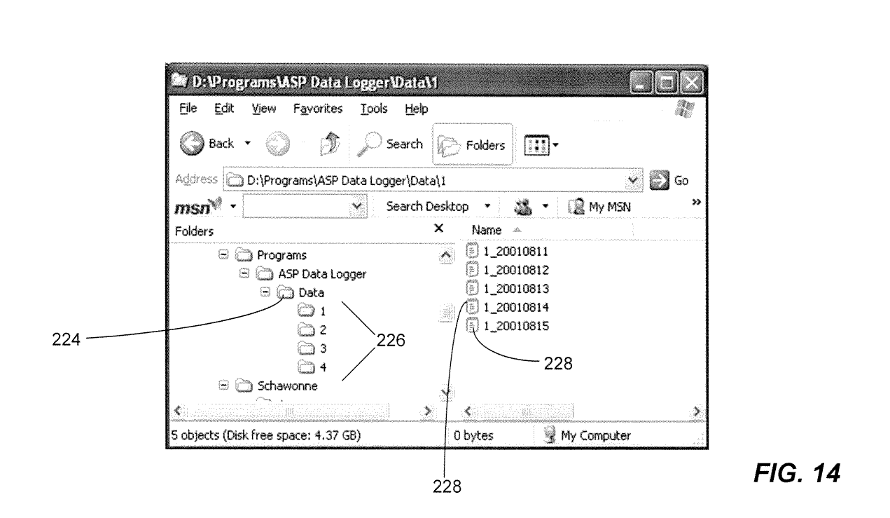

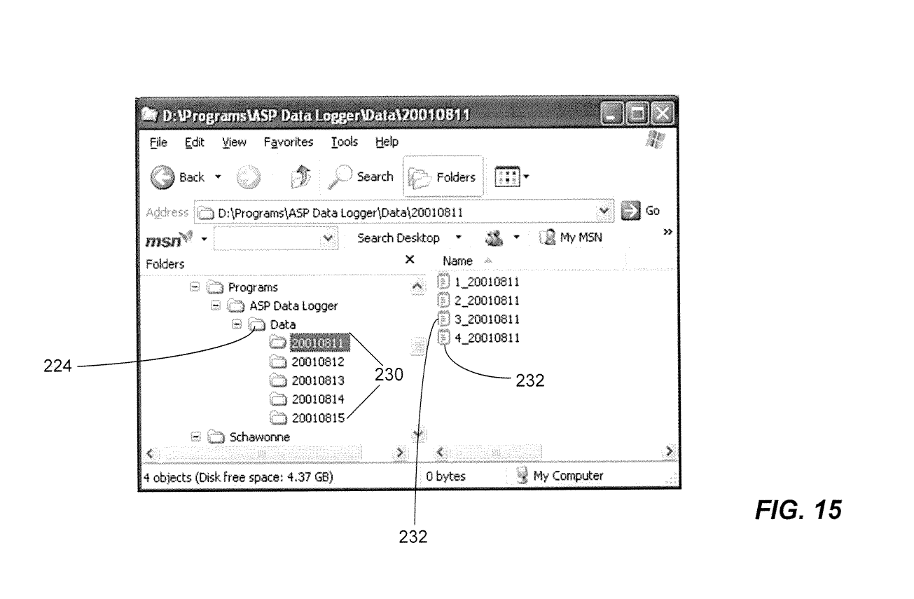

FIGS. 14 and 15 depict two data storage arrangements corresponding with alternative data storage techniques. Each of FIGS. 14 and 15 illustrate file directories in a tree-based hierarchy having a number of levels. A top level 224 may be dedicated to defining a file folder (e.g., “Data”) or other location of all of the data file groups 216 (FIG. 5). The hierarchy may include two additional levels dedicated to defining each data file group 216, as well as each data file 218 within each group 216. For example, the embodiment shown in FIG. 14 has a level 226 that specifies the respective process parameter of the plurality of process parameters. In this exemplary case, the level 226 includes a plurality of file folders, with each file folder dedicated to one of the process parameters. The process parameter folders may be identified by tag name or via any other desired scheme (e.g., process parameters 1, 2, 3, and 4). Moving down from the data parameter level, the next level of the hierarchy then specifies a time frame during which the process data was collected. As shown in FIG. 14, each file folder includes an array of data storage files 228 dedicated to various time periods, frames or windows during which the process data collected. Each file 228 may be named in accordance with the specified time frame and the respective process parameter. In the exemplary case shown in FIG. 14, file name 1_{—}20010811 may correspond with process parameter number 1 and the process data collected during a time period (e.g., day) occurring on Aug. 11, 2001. Each file may correspond with any length of time, and is not limited to day-length time periods. Within each data storage file 228, the data may be stored in any desired format, including, for instance, tab-delimited plain (ASCII) text or binary formats.

In the alternative embodiment shown in FIG. 15, the data level 224 similarly includes a file folder level 230 and a lower or subordinate level of data files 232. However, in this case, the level 230 of the file hierarchy specifies the time frame during which the process data was collected, and the subordinate level specifies the respective process parameter. In the exemplary case shown, each file folder is named in accordance with the data collection time period (i.e., the date of the day upon which the data was collected), although any other naming convention may be used. Within each folder, the files may be named to indicate the process parameter (e.g., parameter 1, 2, 3 or 4), as well as the time frame of the data collection.

In either exemplary embodiment, each file contains 228 or 232 contains one day (or other desired standard time period) of data for a respective process parameter.

Data storage in accordance with these arrangements may be useful in connection with the processing of process parameter data in which data logging is ongoing, such that data backups and data purging steps are desired. To backup all data stored in accordance with the embodiment of FIG. 15, one need only copy the appropriate folders to the backup destination (e.g., an external CD). To purge the oldest data from the database, one need only delete the folders corresponding to the oldest data. Both of these operations may be performed either manually, or automatically, by accessing the data file hierarchy information and proceeding accordingly.

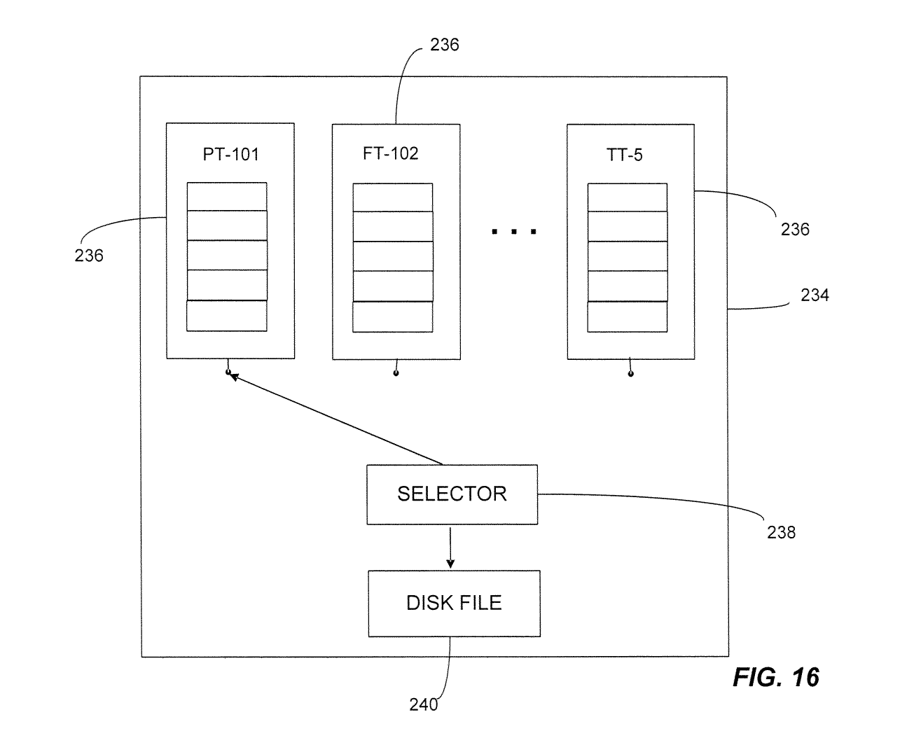

FIG. 16 depicts a data logging interface 234 that implements a data buffering technique to support either one of the data storage arrangements described above. The data logging interface 234 may be integrated with the data buffer 116 (FIG. 5). Alternatively, the data logging interface 234 may be implemented by (or integrated within) the data capture interface module 114 (FIG. 5) to control the contents of the data buffer 116 externally.

Each time a new sample of process data is received, the buffering technique helps efficiently process the data. Typically, the processing is not as straight forward as simply appending the data to the end of the appropriate data file 228, 232. At each sampling interval, a new set of samples is collected for the process variables. In an exemplary case, as many as 200 process variables are sampled at a rate of once per second. Each second therefore brings a new sample to be appended to each of 200 different data files. The data buffering technique described below efficiently processes these incoming samples, thereby minimizing the load on the file input/output hardware, software, etc., as well as the CPU. More generally, other data buffering techniques may be used in connection with the data storage arrangements and techniques described above.

In accordance with the disclosed buffering technique, separate arrays 236 temporarily store data for each process variable, respectively. In the exemplary embodiment shown in FIG. 16, three process parameters, PT-101, FT-102 and TT-5 have respective arrays 236 dedicated thereto. Each array 236 can store a certain number of samples. A hash table (not shown) may be used to quickly access the appropriate array 236, or samples within a particular array 236. In any case, when a new sample of data is read, the data is stored in the appropriate array 236, and not immediately written to the files (see, e.g., FIGS. 14 and 15). During this time, a selector 238 sequentially moves from one process variable to the next, accessing each array 236 at a desired time interval (e.g., one second). When the selector 238 accesses an array 236, the selector 238 directs the contents of the array 236 to an appropriate file 240 within the data storage hierarchy. When the selector 238 reaches the last process variable, the selector 238 returns to the first process variable, and begins the sequential procedure again.

Using the selector 238 and the above-described buffering technique, the database needs to only open and write to one file at a time, as opposed to opening and writing to many (e.g., 200) files at once.

Automated Scanning Techniques for ASP Module Identification

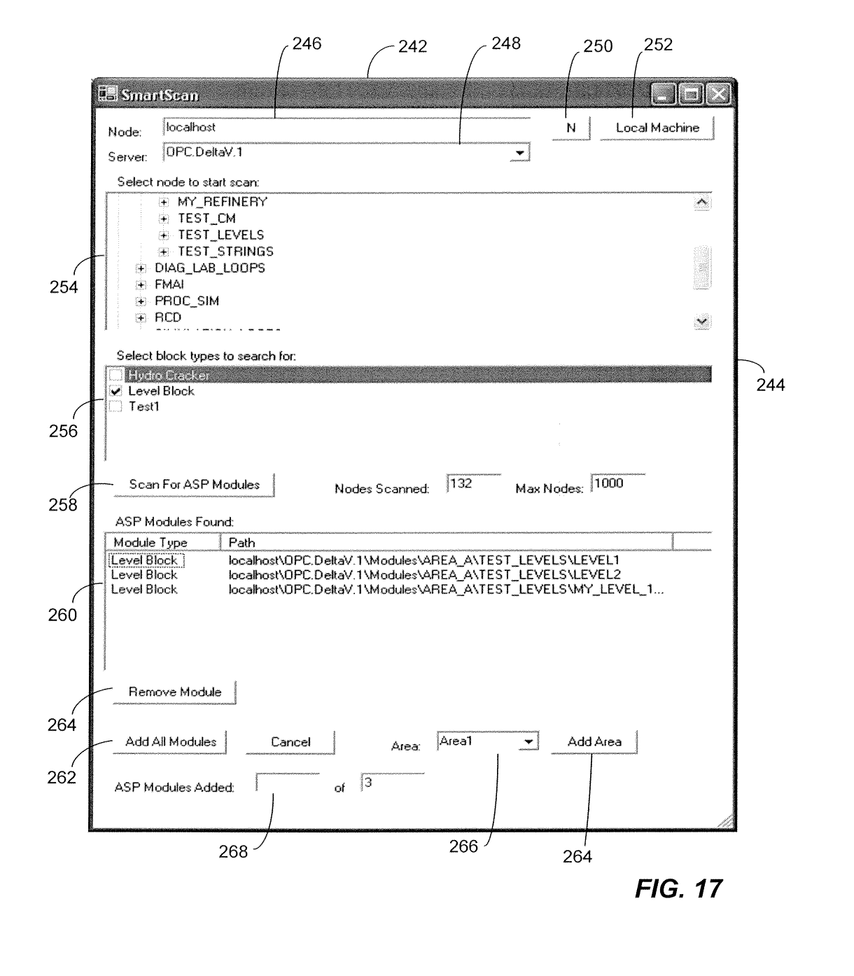

FIG. 17 shows a dialog of a user interface display 242 that may be generated by the data capture configuration module 112 (FIG. 5) and implemented in conjunction with an automated configuration procedure of the block 158 (FIG. 8). The automated configuration procedure provides an automated technique for scanning the hierarchy of the process control system to identify the control modules and/or process parameters to be logged and monitored by the system 104. In this way, the automated technique may be utilized to identify and support the monitoring of, for instance, all of the ASP modules within a process control system. Once the control modules or process parameters are identified, a user may opt to add the modules or process parameters to those selected for monitoring and data capture.

The interface display 242 generally supports configuring the scanning procedure. A dialog window 244 of the interface display 242 has data fields 246 and 248 to support user identification of a process control network node (e.g., process workstation or other machine) and server (e.g., OPC server) to be scanned. To that end, user selection controls (e.g., buttons) 250 and 252 are also provided to lead the user to further information regarding the network, its nodes, and the local machine (e.g., user workstation) on which the data capture configuration module 112 is being implemented. With these selections, a graphical, tree-based view of the hierarchy to be scanned is presented in a panel 254. Selection of one of the nodes depicted in the panel 254 determines the node in the hierarchy at which the scanning will start. In this exemplary case, the dialog window 244 also includes a panel 256 that lists all of the different types of ASP modules that have been defined. The panel 256 includes checkboxes to support user selection of the ASP modules for which the scanning procedure is to search. In other embodiments, the panel 256 may list other module types for selection.

When the user clicks on a button 258, the data capture application 106 (FIG. 5) accesses the hierarchy and scans for all of the selected ASP modules. The manner in which such modules are identified during the scan may be facilitated by a pre-specified format, as described below in conjunction with one aspect of the disclosure. Each ASP module found during the scan procedure is then listed in a panel 260. The user may then click on an “Add All ASP Modules” button 262, and all of the process parameters (e.g., OPC items) associated with the ASP Modules are then added to the main hierarchy of the data capture application 106 for monitoring and logging. To modify the list of ASP modules, the dialog window 244 further includes a “Remove Module” button 264, which may be selected after one or more of the modules listed in the panel 260 is selected or highlighted by the user.

When adding the modules to the data capture hierarchy, the user may organize the modules within defined areas. A button 264 provides the user with an opportunity to define additional areas. Once defined, the areas are made available to the user via a dropdown box in a data field 266. The modules found via the scan are then allocated to the area selected via the data field 266 when the user selects the “Add All Modules” button 262. The display window 244 also includes a data field 268 to provide status information on the module allocation process.

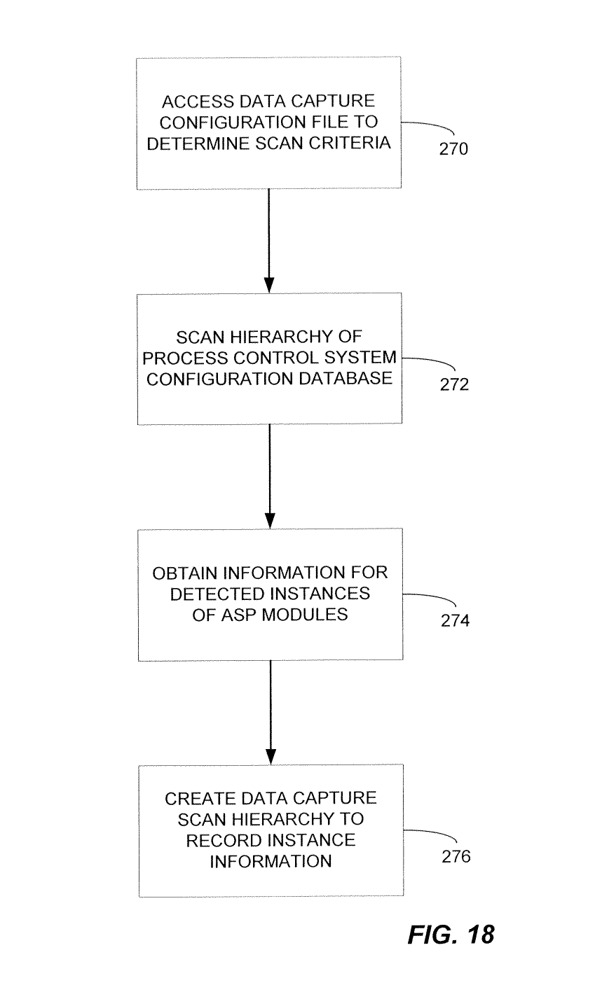

The steps and procedures implemented in accordance with one embodiment of the scanning technique are shown in FIG. 18. When the user elects to start the scan, a block 270 accesses one or more files that have been created to facilitate the configuration process (hereinafter referred to as “configuration file(s)”). The configuration file(s) may include data indicative of the ASP modules to be located by the scanning procedure. The data is then used as scan criteria during the scan, which may be implemented by a block 272. The configuration file(s) may include one or more files dedicated and incorporated within the data capture system 104 (FIG. 5) or, alternatively, include or involve one or more files associated or integrated with the process control system. For example, networks implementing DeltaV™ systems may present FHX files that specify information regarding elements of the process control system. In some cases, the data capture application 106 may access that information for use in configuration procedures. More generally, the configuration file(s) may provide or store the information in any format, including, for instance, a variety of text-based formats.

The data or information in the configuration file(s) may identify one or more function blocks, parameters or other elements utilized in each ASP module. In OPC hierarchies, the function blocks and process parameters utilized in the implementation of a module, such as an ASP module, are identified in the OPC hierarchy. The names of the blocks and parameters involved in a selected ASP module may then be used as criteria of the scan of the OPC hierarchy. The OPC hierarchy may be made available for such scans by accessing the process historian or other database of the process control system. Other embodiments may utilize other aspects or characteristics (i.e., indicia) of the ASP modules made available by the process control system. In any case, data representative of such indicia may then be stored in the configuration file(s) accessed by the block 270 to support the hierarchy scan.

Information regarding each detected instantiation of the ASP modules is obtained in a block 274. The implementation of the block 274 may be conducted either during the scan or following completion of the scan, or both, as desired. Once obtained, the information regarding each instantiation may then be used in a block 276 to create a data capture hierarchy for the data capture application 106. The data capture hierarchy facilitates the recordation and monitoring of process data once the data logging operations begin. To this end, alternative data arrangements or structures may be used, as desired.

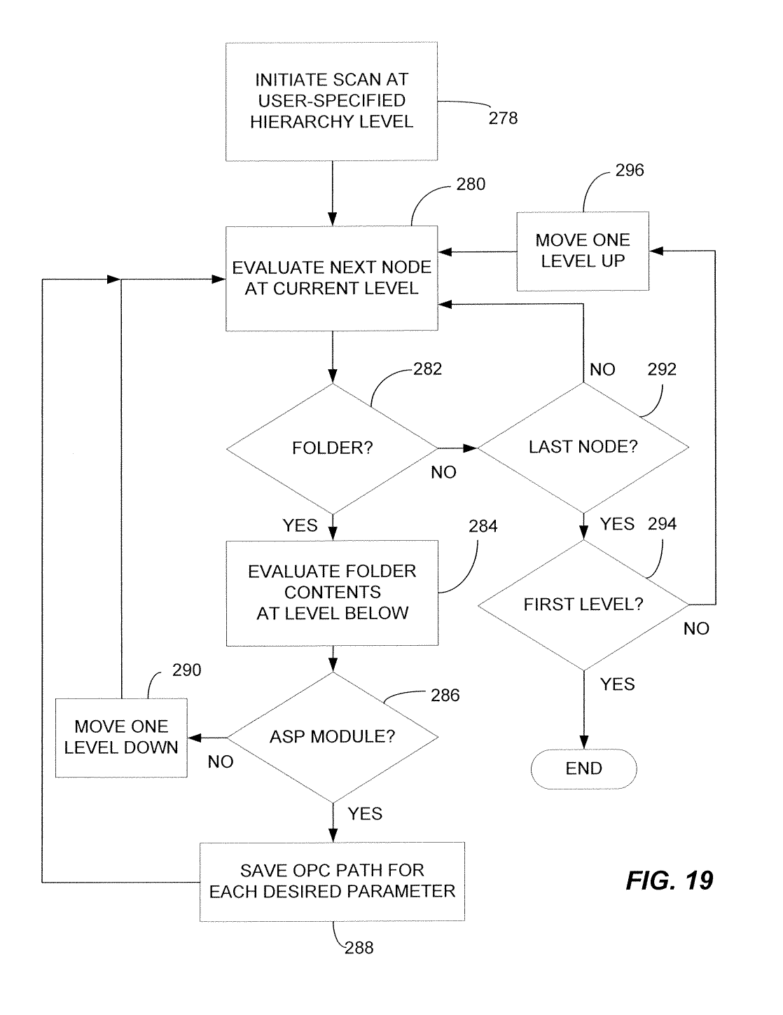

With reference now to FIG. 19, a recursive scan procedure is now described in connection with an embodiment in which the elements of the process control system are organized in a multi-level arrangement, or hierarchy, such as an OPC hierarchy. Generally speaking, the scan procedure is directed to detecting the presence of one or more search criteria (e.g., indicia of an ASP module) within the arrangement of elements of the process control system. In this exemplary case, each node or other element of the process control system has a dedicated folder in which the indicia of an ASP module (or other desired element) may be found. Thus, each ASP module for which data is to be logged has a dedicated folder, which, in turn, has a number of sub-folders associated with the process parameters involved in the module. See, for example, the hierarchy of folders shown in FIG. 4. The presence of certain function blocks or process parameters may be relied upon as an indication of an instance of the ASP module.

Although described in connection with ASP modules, practice of the scan procedure is not limited to scanning for ASP modules, or any other type of module. On the contrary, the recursive nature of the procedure may be implemented in a variety of contexts, including, for instance, other arrangements in which elements of the process control system are organized in levels or layers, and/or arrangements in which process parameters are grouped or otherwise associated in accordance with a process control routine.

The recursive procedure begins in a block 278, the implementation of which initiates the scan at a user-specified level of the hierarchy. The level may be specified via the selection of a node via the panel 254 of the display interface 242 shown in FIG. 17. The next node at the selected level is evaluated by a block 280 in accordance with the scan criteria. In one embodiment, the presence of an ASP module may be indicated by the names of the function blocks, process parameters or other elements associated with the ASP module. In some cases, the input and output variables of the ASP module are utilized as the indicia of the ASP module. More generally, the search criteria may accordingly correspond with the block, parameter or other names of the indicative elements. To that end, a decision block 282 determines whether the evaluation of the next node revealed a folder. If yes, control passes to a block 284 that evaluates the contents of the folder to determine the folder or file names of the level below the current level. A decision block 286 then determines whether any of those names correspond with any of the scan criteria, i.e., the parameter names of any of the ASP modules to which the scan is directed. If a sufficient number (e.g., all) of the scan criteria for a certain ASP module are found to match the folder contents evaluated by the block 284, then control passes to a block 288 that saves information regarding the hierarchy location currently being processed. For instance, an OPC path may be stored for each parameter associated with the ASP module or otherwise desired to be logged. If not, control passes to a block 290 that changes the current level to the subordinate level, thereby moving the focus of the scan procedure to the level of the folder contents. Control then returns to the block 280 for evaluation of the first node at that level.

In this fashion, the scan procedure eventually reaches the lowest level of the hierarchy. At that point, the decision block 282 passes control to another decision block 292 that determines whether the last node at the level has been reached. If not, the block 292 passes control to the block 280 for evaluation of the next node. Otherwise, the scanning of the current level is complete, and control passes to a decision block 294 to determine whether the recursive nature of the procedure has brought the current level back up to the initial level yet. In that case, the scan procedure is finished. If not, then control passes to a block 296 that moves the current level one level up for evaluation of the next node. Through the operation of the blocks 280, 290 and 296, the scan procedure recursively proceeds throughout all of the nodes in the initial level and any nodes in levels depending therefrom.

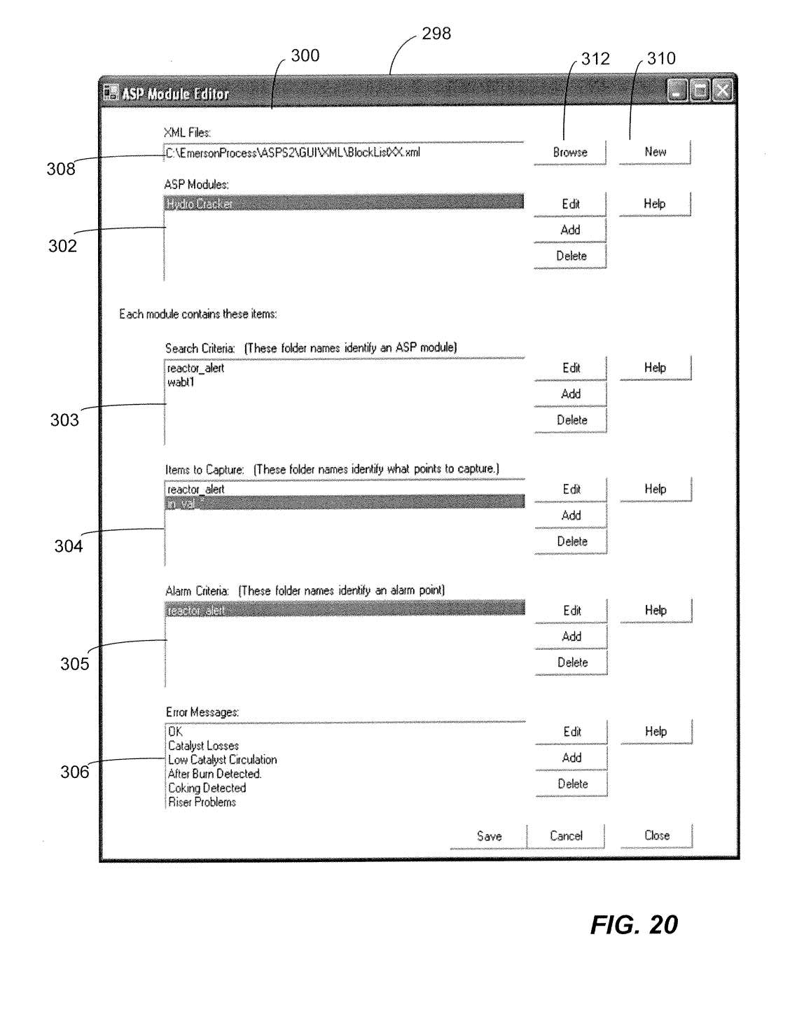

Turning to FIG. 20, a user interface display 298 may be provided to facilitate the specification by the user of the indicia of the ASP modules or other elements of the process control system to which the scan procedure is directed. In the exemplary case shown, ASP modules are the targets of the scan procedure, and the indicia are the names of the function blocks or process parameters involved in the processing of the ASP module. While other characteristic indicia may be used, in this case, the scan procedure may proceed by comparing the names of the file folders with the search criteria, as described above, because each instantiation of an ASP module will contain sub-folders dedicated to each such function block or process parameter. In this way, the user interface display 298 helps the user configure or prepare the data capture configuration module 112 for the scan procedure.

The user interface display 298 includes a display window 300 having a number of panels 302-306 directed to support the addition, deletion, and editing of configuration information for the scan procedure. Such configuration information may be stored in one or more configuration files that are subsequently accessed by the data capture configuration module 112 during the execution of an automated scan. In some embodiments, the configuration information defines the process parameters and, thus, the sub-folder names of the ASP modules or other elements. More generally, the configuration information defines one or more format or other characteristic indicia of the targets of the search. The characteristic indicia are then used during the search as search criteria.

The format or other characteristics of each target ASP module may be set forth in a respective configuration file. The data capture application 106 (FIG. 5) uses these configuration files to determine the search criteria for the scan procedure. Each configuration file may store the format characteristics in XML format, or any other desired format, such as tab-delimited text, or a textual format similar to that used in DDL and DeltaV FHX files, or other files having a format similar to the C programming language.

In some embodiments, each configuration file may also specify a level in the OPC hierarchy or other arrangement of process control elements within the process control system at which the indicia (e.g. search criteria or process variables) may be found. This level may be specified as a level relative to the top level (module name) of the ASP module. ASP modules may occupy multiple levels within the hierarchy. As a result, the folder associated with a process parameter may be at any level below the ASP module in some cases. A level item specified within the configuration file for each parameter may be accessed and utilized by the data capture configuration module 112 (FIG. 5) during the implementation of a scan procedure to determine the level of the OPC hierarchy below the ASP module name at which the search should be conducted. Specifying the level of the process parameters allows for a more robust scanning routine, ensuring that only the ASP module(s) meeting the specified criteria will be found. Defining multiple levels for parameters in an ASP module may be useful in a case where the ASP module performs a diagnostics routine based on a weighed average (or some other function) of multiple process measurements. In such a case, the process measurements may be collectively contained in a folder below the weighted average node, and therefore the process measurements are at a lower level than the weighted average. One example of such an ASP module is a Hydrocracker ASP module, which uses a Weighted Average Bed Temperature (WABT) and the configuration of which is illustrated in FIGS. 20, 22 and 23.

In the exemplary embodiment shown in FIG. 20, the panels 302-306 are utilized to specify the contents of the configuration file. Upon completion of the forms made available via the buttons and other user interface elements associated with the panels 302-306, the configuration file contains the following information for each ASP module:

1. the name of the ASP module type, as shown in the panel 302;

2. the module characteristics, in this exemplary case, tag names (e.g., sub-folders) of function blocks to be used as search criteria to identify an ASP module, as shown in the panel 303 (the information displayed in the panel 303 corresponds with the ASP module selected in the panel 302);

3. the OPC items, such as process variable inputs, to capture for the selected ASP module, as shown in the panel 304;

4. the alarms (or other process variable outputs) to monitor for the selected ASP module, as shown in the panel 305;

5. any error messages associated with each possible value in the alarms, as shown in the panel 306; and

6. any process variables associated with each alarm (these variables may be used by the data capture monitoring module 122 (FIG. 5) to graph data associated with an alarm).

In this example, the following information is specified in the form:

1. the name of this ASP Module type is “Hydro Cracker”;

2. the function block sub-folders that indicate or reveal a folder as an ASP Module are “REACTOR_ALERT” and “WABT1”;

3. the items to capture for each ASP module found are “reactor_alert” and “in_val_*” (in this case, the wild card character “*” is used to specify multiple items, such as OPC items “in_val_{—}1”, “in_val_{—}2”, etc.);

4. the name of the alarm variable for the ASP module is “reactor_alert”;

5. the alarm messages for the alarm variable are:
a. Catalyst Losses
b. Low Catalyst Circulation
c. After Burn Detected
d. Coking Detected; and,
e. Riser Problems;

6. for each alarm message, the following data is also stored:
a. the name of a help file (PDF, Word, HTML, etc.) providing additional information pertaining to each alarm;
b. the severity level of the alarm (this item may control an icon that appears in the user interface display of the data capture application 106); and,
c. a list of data points associated with the alarm to be graphed, plotted or otherwise made available in connection with the alarm.

Wild card characters in addition to “*” and other codes may be used in the configuration file(s) to support scans for multiple parameters having similar names. Similarly, wild card characters may also be used to specify multiple items to capture during the data logging procedure.

The display window 298 may also provide a data field 308 to specify path and file name information for the configuration file. The data field 308 may be used to pull up the configuration information for a previously generated file for editing, viewing, etc. Alternatively or additionally, the data field 308 may be used to specify the path and file name information for a new file to be created using the panels 302-306. User selectable controls, or buttons, 310 and 312 are provided to that end to initiate and support the process, respectively.

With a help file specified for an alarm, the implementation of the data monitoring module 122 (FIG. 5) of the data capture application 106 (FIG. 5) generates a user interface that provides an opportunity for the display of additional information regarding the alarm. As described below, when an alarm occurs, the user can select (e.g., double-click) the alarm to launch the help file providing additional information.

The following is an exemplary configuration file that specifies, in XML format, the characteristics of the hydrocracker reactor type of ASP module discussed above.

```
<?xml version=“1.0”?>
<BlockList xmlns:xsd=“http://www.w3.org/2001/XMLSchema”
xmlns:xsi=“http://www.w3.org/2001/XMLSchema-instance”>
  <Name>ListName</Name>
  <Blocks>
    <Block devicetype=“6”>
      <Name>Hydro Cracker</Name>
      <SearchFolders>
        <SearchFolder itemid=“5”>
          <Name>reactor_alert</Name>
          <Level>1</Level>
        </SearchFoldrer>
        <SearchFolder itemid=“1”>
          <Name>wabt1</Name>
          <Level>1</Level>
        </SearchFolder>
      </SearchFolders>
      <OutputItems>
        <OutputItem itemid=“5”>
          <Name>reactor_alert</Name>
          <Point>CV</Point>
          <Level>1</Level>
          <UpLevel>0</UpLevel>
          <Path />
        </OutputItem>
        <OutputItem itemid=“2”>
          <Name>in_val_*</Name>
          <Point>CV</Point>
          <Level>2</Level>
          <UpLevel>1</UpLevel>
          <Path>wabt*</Path>
        </OutputItem>
      </OutputItems>
      <AlarmItems>
        <AlarmItem itemid=“1”>
          <Name>reactor_alert</Name>
          <Point>CV</Point>
          <Level>1</Level>
          <AlarmOutItems>
            <OutputItem itemid=“0”>
              <Name>in_val_*</Name>
              <Point>CV</Point>
              <Level>2</Level>
              <UpLevel>1</UpLevel>
              <Path>wabt*</Path>
            </OutputItem>
          </AlarmOutItems>
        </AlarmItem>
      </AlarmItems>
      <ErrorMessages>
        <ErrorMessage messageid=“0”>
          <Message>OK</Message>
          <FileName>test.htm</FileName>
          <Severity>3</Severity>
        </ErrorMessage>
        <ErrorMessage messageid=“1”>
          <Message>Catalyst Losses</Message>
          <FileName>test.htm</FileName>
          <Severity>1</Severity>
        </ErrorMessage>
        <ErrorMessage messageid=“2”>
          <Message>Low Catalyst Circulation</Message>
          <FileName>test.htm</FileName>
          <Severity>1</Severity>
        </ErrorMessage>
        <ErrorMessage messageid=“3”>
          <Message>After Burn Detected.</Message>
          <FileName>test.htm</FileName>
          <Severity>1</Severity>
        </ErrorMessage>
        <ErrorMessage messageid=“4”>
          <Message>Coking Detected</Message>
          <FileName>test.htm</FileName>
          <Severity>1</Severity>
        </ErrorMessage>
        <ErrorMessage messageid=“5”>
          <Message>Riser Problems</Message>
          <FileName>test.htm</FileName>
          <Severity>1</Severity>
        </ErrorMessage>
      </ErrorMessages>
    </Block>
  </Blocks>
</BlockList>
```

The XML script utilizes a number of elements to specify the characteristics of the ASP module, including “Name” (module name), “Point” (process parameter or variable to be captured), “Level” (the level in the hierarchy at which the folder is located, where level 1 may correspond with the current level), “UpLevel” (parameter indicative of a summary of the data at the next highest level), “FileName” (name of the help file for an error message), and “Severity” (element indicative of the severity level of the error message).

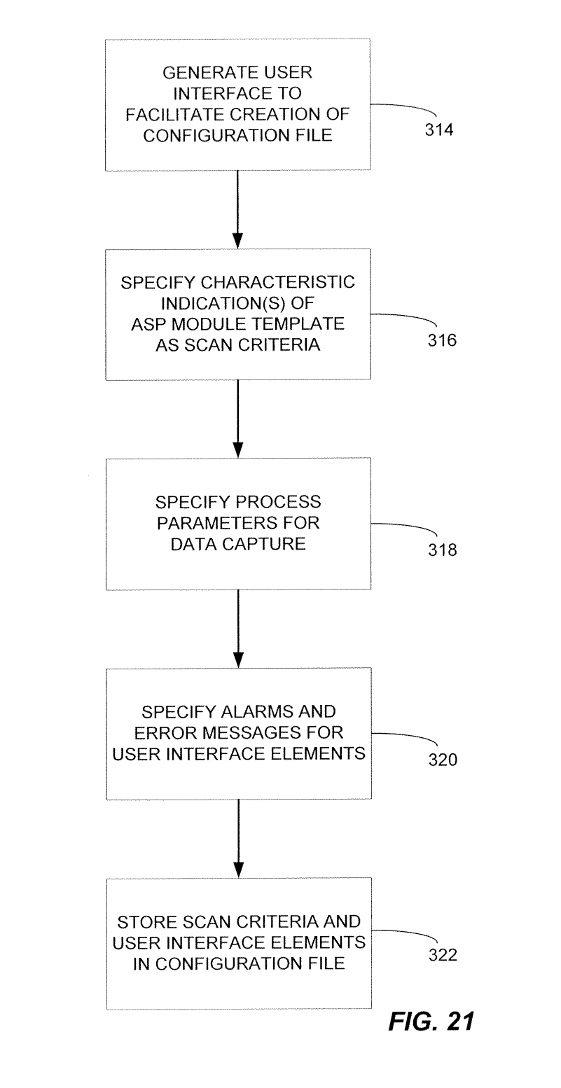

The steps taken in conjunction with the user interface display 298 (FIG. 20) are set forth in the flow diagram of FIG. 21. The steps may correspond with the actions facilitated or implemented by the configuration module 112 (FIG. 5) and/or, more generally, the data capture application 106 (FIG. 5) during a configuration process. The steps may alternatively be viewed as operational states of the data capture application 106 during the configuration process. As a result, the steps or states may be implemented in any desired order, and not necessarily in the order shown. Moreover, the implementation of the configuration process need not include each of the depicted steps or states, but rather may involve a subset thereof as desired.

The embodiment shown in FIG. 21 is described in conjunction with the exemplary user interface display 298 of FIG. 20, although the configuration process is not limited thereto. Initially, a user interface, such as the interface display 298, is initially generated in a block 314 to facilitate the creation of the configuration file. Through the user interface 298, the characteristic indication(s), e.g., function block names, of one or more ASP modules are identified by a user in a block 316 and specified as the scan criteria via the panel 303. To further configure the scan procedure, a user may specify in connection with a block 318 and via the panel 304 the process parameters to be captured by the data capture application 106 (FIG. 5) during the procedure. Alarms and error messages may be similarly specified via the panels 305 and 306, respectively, in connection with a block 320. More generally, the block 320 may be used to specify any elements of the user interface generated by the data capture application 106 (FIG. 5). Such user interface elements may include, for instance, error messages, help information and other information to be provided during or as a result of data logging. Finally, or at any time throughout the configuration process, the user may store the scan criteria and other configuration data specified thereby in the configuration file(s) in a block 322. To this end, user selectable controls, buttons and/or other user interface elements, such as the data field 308, may be provided to facilitate the creation and/or updating of the configuration file.

In some embodiments, some of the configuration information specified via the user interface display 298 and the configuration process of FIG. 21 may be automatically generated for specification in the configuration file(s). For instance, all of the function blocks and/or process parameters associated with the selected ASP module may be automatically specified. Such information may be available in embodiments in which the data capture system 104 (FIG. 5) and the process control system are integrated or otherwise suitably linked. Similarly, if the process control system is configured to generate alarms in connection with the detection of certain operating conditions related to the ASP module (or other element), then such alarms may also be automatically specified. In these cases, the two systems may be implemented on the same workstation to facilitate the sharing of information between the process control system and the data capture system 104 (FIG. 5), or on multiple workstations linked via a process control network of the process control system. In either case, the two systems may share resources (data files, memories, processors, etc.), or otherwise have access to the same resources, to enable such integration.

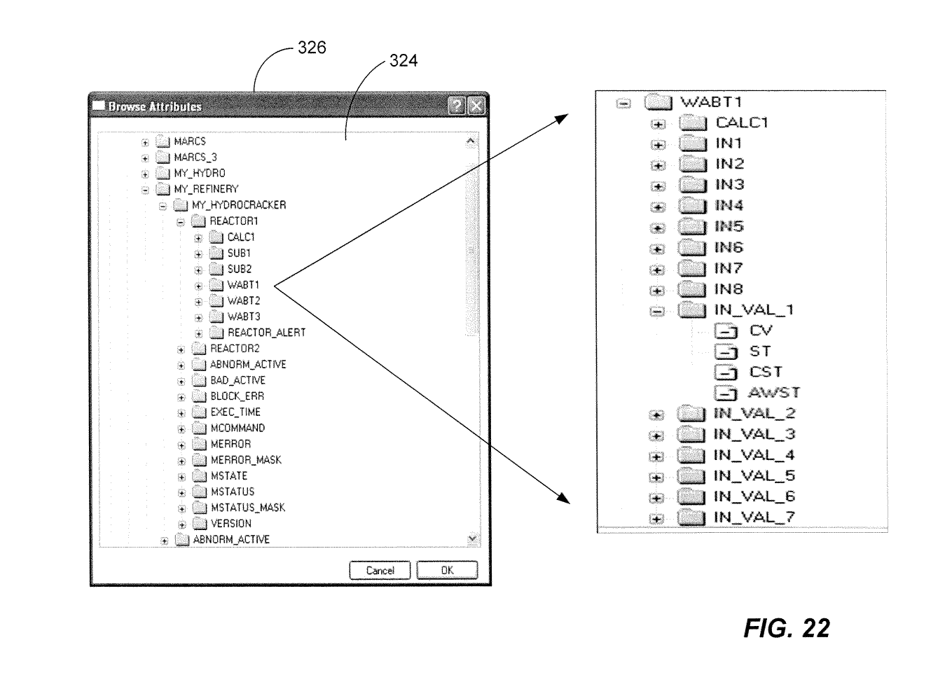

FIG. 22 depicts an exemplary OPC hierarchy that may be processed by the configuration module 112 (FIG. 5) for subsequent data logging and process monitoring by the data capture application 106 (FIG. 5). Information indicative of the OPC hierarchy is set forth in a display window or panel 324 of a user interface display 326. Via the display window 324, a user can view the graphical representation of the hierarchy to determine that the hierarchy includes multiple instantiations of an ASP module type configured for use in connection with a hydrocracker unit of a refinery, including one instantiation, REACTOR1, shown in exploded form and associated with a reactor of the unit. Another instantiation of this ASP module type, REACTOR2, is also indicated as associated with another reactor of the hydrocracker unit.

The automated scan procedure described above, however, may be relied upon to detect and identify the ASP modules. Otherwise, a user may be forced to navigate and analyze the entire hierarchy of the process plant, which would typically be much more complex and extensive than the portion shown in FIG. 22. With the scan procedure, any instantiations of an ASP module type of interest can be detected and identified. In this case, the ASP modules, REACTOR1 and REACTOR2, may be detected using the configuration information established via the interface display 298 (FIG. 20). As described above, each instantiation of the desired ASP module type would be detected or uncovered, as the same set of function blocks, identified via the sub-folders one level below, would be present. In this exemplary case, the function blocks WABT1 and REACTOR_ALERT have been specified as characteristic indicia of an ASP module for a hydrocracker unit. The expanded view of the REACTOR1 module depicts the hierarchy below the REACTOR1 module, revealing the presence of the function blocks WABT1 and REACTOR_ALERT. The module indicated with the folder REACTOR2 may have an identical set of function blocks as sub-folders beneath it in the hierarchy and, thus, would be identified as an ASP module by the scan.

FIG. 22 also depicts the process parameters associated with the WABT1 function block, any number of which may be selected or specified via the interface display 298 (FIG. 20) as the parameters for which data is to be captured by the data capture application 106 (FIG. 5). This exemplary function block may provide the functionality underlying the calculation of a weighted average bed temperature value for a reactor. The hierarchy level below the function block level includes a number of folders, each folder dedicated to a process parameter involved in the implementation of the WABT1 function block. As shown in FIG. 20, some of these parameters, IN_VAL_1 through IN_VAL_7, have been selected as parameters for which data is to be captured.

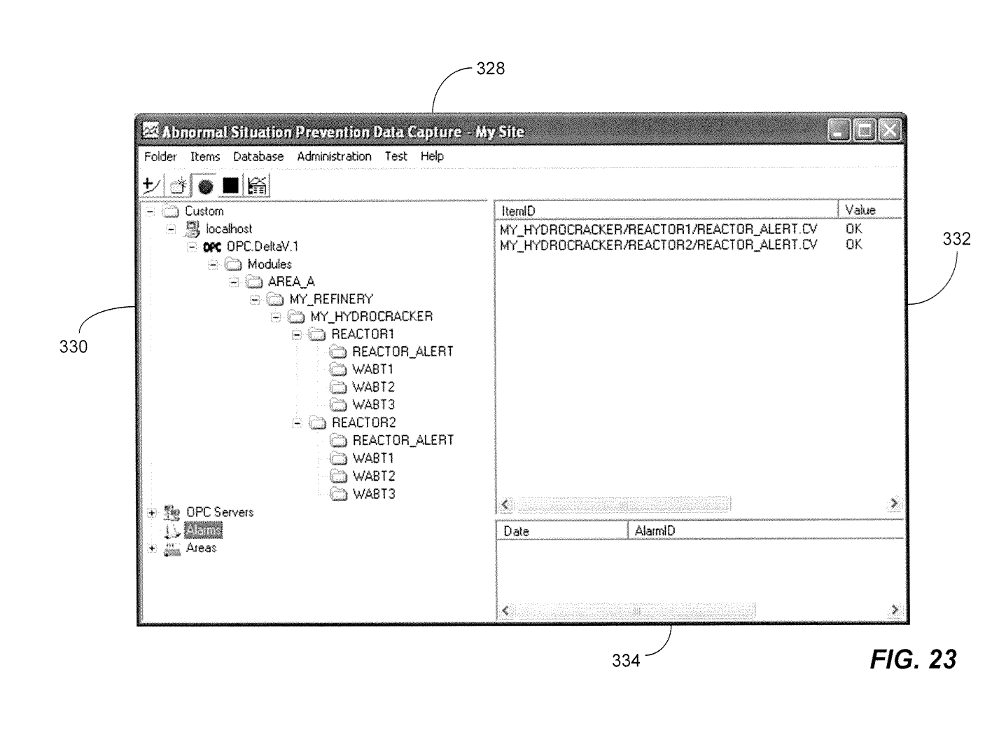

FIG. 23 depicts an exemplary user interface display 328 similar to the display of FIG. 6 but shown in connection with the exemplary configuration information specified via the interface display 298 (FIG. 20) and the exemplary data capture hierarchy shown in FIG. 22. The interface display 328 has a panel 330 to display a data structure created by the configuration module 112 of the ASP data capture application 106 (FIG. 5) after implementation of the automated scan procedure. The data structure may include a hierarchy similar to the folder structure of the underlying OPC or other hierarchy presented by the process control system. The hierarchy shown in the panel 330 differs from the OPC hierarchy in that the only nodes or other elements of the OPC hierarchy shown are those involved or included within the ASP (or other) modules for which data is to be captured and monitored by the data capture application. This subset of the OPC hierarchy may present a convenient user interface, especially when viewing or navigating the OPC hierarchy would be unnecessarily and/or undesirably complex and extensive.

The interface display 328 may also be used to monitor the operation of the ASP (or other) modules of interest during, for example, a field test, or other on-line or runtime context. To this end, panels 332 and 334 are directed to showing status information for one or more process variables, alerts, messages or other parameters involved with the ASP (or other) modules being monitored by the data capture application 106 (FIG. 5). The panel 332 may be dedicated to displaying a status indication for each alert parameter associated with the ASP modules being monitored. The panel 334 may be dedicated to displaying an identification and other information (e.g., date, time, etc.) associated with any errors currently present.

The interface display 328 may be useful in field test or other testing contexts where the user interfaces generated for operators of the process control system should not depict the errors and other status information of ASP (or other) modules. Such modules may be, for instance, under development and not qualified for use by the operators or otherwise relied upon in connection with an on-line process. A separate user interface, such as the interface display 328, thus supports the development and testing of ASP (and other) modules without confusing operators and other personnel monitoring the on-line process.

Selecting an item or error in either of the panels 332 and 334 may result in the generation of a further user interface item (e.g., a drop-down menu, window) that prompts for selection of one or more additional user interface options for providing further information regarding the selected item or error. Examples of additional user interface options include the display of trending data or other graphs, as well as help information.

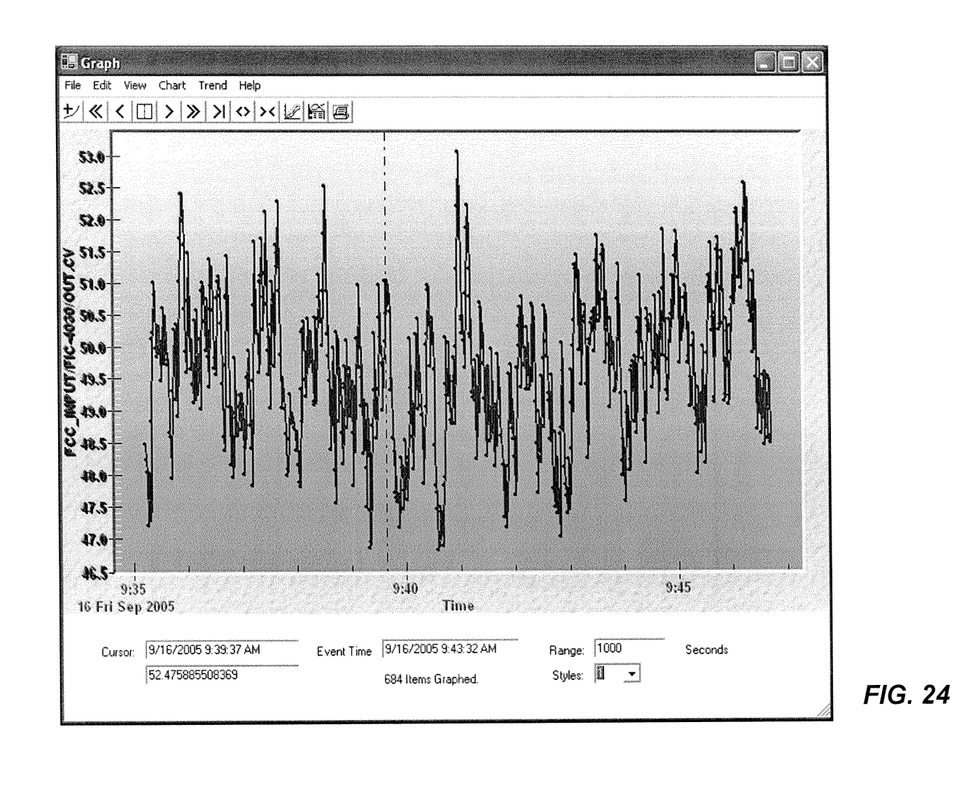

More specifically, the error messages specified via the interface display 298 (FIG. 20) and later stored in the configuration file may be accessed for display in connection with the interface display 328. If, for instance, the data capture application 106 (FIG. 5) is monitoring a certain ASP module, and an alarm is detected and identified via the panel 334, then selection of the alarm may result in the generation and display of a meaningful message in accordance with the text and other information stored in the configuration file. Similarly, when an alert is shown in the interface display 298, the user may select the alert, resulting in a menu option such as “Trend Relevant Data”. Selection of the menu option may then direct the data capture application 106 (e.g., the data monitoring module 122) to generate a graph of the process variables, relative to that alert, as defined in the configuration file. An exemplary graph is shown in FIG. 24.

One of ordinary skill in the art will recognize that the exemplary systems and methods described above may be modified in various ways. For example, blocks may be omitted or reordered, additional blocks may be added, etc. For example, with regard to FIG. 7, the block 146 could be implemented at a different point in the flow. Similarly, the block 148 could be implemented as part of a separate routine, and thus it could actually occur at various points with the flow of FIG. 7 depending upon when a suitable command is received to initiate implementation of the separate routine.

The above-described examples involving ASP modules and ASP blocks are disclosed with the understanding that practice of the disclosed systems, methods, and techniques is not limited to such contexts. Rather, the disclosed systems, methods, and techniques are well suited for use with any diagnostics system, application, routine, technique or procedure, including those having a different organizational structure, component arrangement, or other collection of discrete parts, units, components, or items, capable of selection for monitoring, data collection, etc. Other diagnostics systems, applications, etc., that specify the process parameters being utilized in the diagnostics may also be developed or otherwise benefit from the systems, methods, and techniques described herein. Such individual specification of the parameters may then be utilized to locate, monitor, and store the process data associated therewith. Furthermore, the disclosed systems, methods, and techniques need not be utilized solely in connection with diagnostic aspects of a process control system, particularly when such aspects have yet to be developed or are in the early stages of development. Rather, the disclosed systems, methods, and techniques are well suited for use with any elements or aspects of a process control system, process plant, or process control network, etc.

The methods, processes, procedures and techniques described herein may be implemented using any combination of hardware, firmware, and software. Thus, systems and techniques described herein may be implemented in a standard multi-purpose processor or using specifically designed hardware or firmware as desired. When implemented in software, the software may be stored in any computer readable memory such as on a magnetic disk, a laser disk, or other storage medium, in a RAM or ROM or flash memory of a computer, processor, I/O device, field device, interface device, etc. Likewise, the software may be delivered to a user or a process control system via any known or desired delivery method including, for example, on a computer readable disk or other transportable computer storage mechanism or via communication media. Communication media typically embodies computer readable instructions, data structures, program modules or other data in a modulated data signal such as a carrier wave or other transport mechanism. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Thus, the software may be delivered to a user or a process control system via a communication channel such as a telephone line, the Internet, etc. (which are viewed as being the same as or interchangeable with providing such software via a transportable storage medium).

Thus, while the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention.

What is claimed is:

1. A method of configuring a data capture system for a process control system controlling a process, the method comprising the steps of:
determining a characteristic indication of an element of the process control system;
scanning configuration data for the process control system to detect an instance of the element using the determined characteristic indication; and,
recording information identifying the detected instance of the element to configure the data capture system to monitor the detected instance of the element during implementation of the process control system and operation of the process.

2. The method of claim 1, wherein the element of the process control system is adapted to implement a routine to evaluate the operation of the process for an abnormal situation.

3. The method of claim 2, wherein the characteristic indication of the element comprises one or more input/output parameters involved with the routine.

4. The method of claim 2, wherein the characteristic indication of the element is a process variable name for an input parameter utilized by the routine.

5. The method of claim 2, wherein the characteristic indication of the element is a status indicator name for an output generated by the routine.

6. The method of claim 1, wherein the determining step comprises the step of generating a user interface to facilitate user specification of the characteristic indication of the element.

7. The method of claim 6, further comprising the step of specifying via the user interface an aspect of the element to be monitored or captured.

8. The method of claim 7, wherein the aspect of the element is an input parameter utilized by the element.

9. The method of claim 7, wherein the aspect of the element is an output parameter generated by the element as a status indication of the operation of the process.

10. The method of claim 9, wherein the output parameter is a diagnostic alarm.

11. The method of claim 1, wherein the determining step comprises the step of storing the characteristic indication in a configuration file associated with the element.

12. The method of claim 11, wherein the storing step comprises the step of incorporating a parameter name in the configuration file.

13. The method of claim 1, wherein the scanning step comprises the step of analyzing a configuration hierarchy of the process control system for the parameter name.

14. The method of claim 13, wherein the analyzing step comprises executing a recursive routine to search a plurality of nodes of the configuration hierarchy to find the parameter name at or below a first-level node of the plurality of nodes.

15. The method of claim 1, wherein the recording step comprises the step of creating an element hierarchy for the data capture system, the element hierarchy specifying a location of the detected instance of the element.

16. A method of configuring a data capture system for a process control system, the method comprising the steps of:
generating a user interface to facilitate creation of a configuration file for use by the data capture system in connection with identifying an instance of a diagnostic element of the process control system to be monitored by the data capture system;
specifying via the user interface a characteristic indication of the diagnostic element;
specifying via the user interface an aspect of the diagnostic element to be monitored or captured; and,
storing the specified characteristic indication and the specified aspect in the configuration file for the diagnostic element.

17. The method of claim 16, further comprising the step of scanning the process control system using the configuration file to detect the instance of the diagnostic element of the process control system to be monitored by the data capture system.

18. The method of claim 17, further comprising recording information identifying the detected instance of the diagnostic element to configure the data capture system to monitor the detected instance of the diagnostic element during implementation of the process control system and operation of the process.

19. The method of claim 16, wherein the characteristic indication of the diagnostic element is a process variable name for an input parameter utilized in a diagnostic routine of the diagnostic element.

20. The method of claim 16, wherein the characteristic indication of the diagnostic element is a status indicator name for an output generated by a diagnostic routine of the diagnostic element.

21. The method of claim 16, wherein the aspect of the element is an input parameter utilized by the diagnostic element.

22. The method of claim 16, wherein the aspect of the element is an output parameter generated by the diagnostic element as a status indication of process operation.

23. The method of claim 22, wherein the status indication is an alert.
